(19) United States
(12) Patent Application Publication
(10) Pub. No.: US 2011/0009264 A1
(43) Pub. Date: Jan. 13, 2011

(54) HERBICIDAL COMBINATION

(75) Inventors: Erwin Hacker, Hochheim (DE); Christian Waldraff, Vilbel (DE); Dominique Schreiber, Frankfurt (DE); Martin Jeffrey Hills, Idstein (DE); Dieter Feucht, Eschborn (DE); Klaus-Helmut Mueller, Duesseldorf (DE); Ernst Rudolf Gesing, Erkrath-Hochdahl (DE); Georg Bonfig-Picard, Rodenbach (DE)

Correspondence Address: Baker Donelson Bearman, Caldwell & Berkowitz, PC, 920 Massachusetts Ave, NW, Suite 900, Washington, DC, 20001, US

(73) Assignee: Bayer CropScience AG, Monheim (DE)

(21) Appl. No.: 12/739,296

(22) PCT Filed: Oct. 22, 2008
(86) PCT No.: PCT/EP08/08944

§ 371 Date: Sep. 23, 2010

(30) Foreign Application Priority Data
Oct. 24, 2007 (EP) 07020856.6

(51) Int. Cl. A01N 43/66; A01P 13/00; A01P 13/02

(52) U.S. Cl. 504/134; 504/135; 504/133

(57) ABSTRACT

The present invention relates to a herbicide combination comprising components (A) and (B), where (A) is one or more herbicides from the group consisting of 2-iodo-N-[(4-methoxy-6-methyl-1,3,5-triazin-2-yl)carbamoyl]benzenesulfonamide and compounds of the general formula (I)

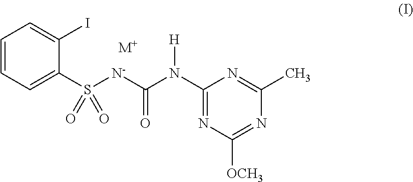

and (B) is one or more herbicides from the group of the (het)arylcarboxylic acids.

A herbicide combination comprising 2-iodo-N-[(4-methoxy-6-methyl-1,3,5-triazin-2-yl)carbamoyl]benzenesulfonamide and/or its salts and herbicidally active compounds from the group of the (het)acrylcarboxylic acids.

The present invention relates to the technical field of the crop protection compositions used against unwanted vegetation, for example by the pre-sowing method (with or without incorporation), by the pre-emergence method or by the post-emergence method in crop plants, such as, for example, in wheat (durum wheat and common wheat), corn, soybeans, sugarbeet, sugarcane, cotton, rice, beans (such as, for example, bush beans and broad beans), flax, barley, oats, rye, triticale, oilseed rape, potatoes and millet (sorghum), pastureland and green/lawn areas. The invention relates in particular to a herbicide combination comprising at least two herbicides, and to its use for controlling unwanted vegetation.

It is known that substituted phenylsulfonylureas have herbicidal properties. These are, for example, phenyl derivatives which are mono- or polysubstituted (for example U.S. Pat. No. 4,127,405, WO 9209608, BE 853374, WO 9213845, EP 84020, WO 9406778, WO 02072560, U.S. Pat. No. 4,169,719, U.S. Pat. No. 4,629,494, DE 4038430).

Furthermore, it is known that certain N-(1,3,5-triazin-2-ylaminocarbonyl)aryl-sulfonamides have herbicidal properties (cf. DE 27 15 786). From WO 2006/114220, it is furthermore known that sulfonamides iodinated at the phenyl ring have herbicidal properties. However, the herbicidal action of these compounds is not in all respects, such as, for example, compatibility, activity spectrum, control of tolerant or resistant species, behavior with respect to follower crops or flexibility of use, satisfactory.

The herbicidal activity of the N-(1,3,5-triazin-2-ylaminocarbonyl)arylsulfonamides against harmful plants is already on a high level; however, it generally depends on the application rate, the respective preparation form, the respective harmful plants to be controlled or the harmful plant spectrum, the climatic conditions and soil conditions, etc. A further criterium is the duration of action or the rate of degradation of the herbicide. Also to be taken into account are, if appropriate, changes in the susceptibility of harmful plants which may occur on prolonged use of the herbicides or in a geographically restricted manner. Activity losses in individual plants can only be compensated to a certain extent by higher application rates of the herbicides, for example because this reduces the selectivity of the herbicides, or an improvement in activity is not observed, not even at a higher application rate.

It was an object of the present invention to provide an improved crop protection composition.

Surprisingly, it has now been found that this object is achieved by using 2-iodo-N-[(4-methoxy-6-methyl-1,3,5-triazin-2-yl)carbamoyl]benzenesulfonamide and/or salts thereof in combination with structurally different herbicides from the group of the (het)arylcarboxylic acids which act together in a particularly favorable manner, for example when they are used for controlling unwanted vegetation in crop plants such as wheat (durum wheat and common wheat), corn, soybeans, sugarbeet, sugarcane, cotton, rice, beans (such as, for example, bush beans and broad beans), flax, barley, oats, rye, triticale, oilseed rape, potatoes and millet (sorghum), pastureland and green/lawn areas.

Compounds from the group of the (het)arylcarboxylic acids are already known as herbicidally active compounds for controlling unwanted vegetation; see, for example, U.S. Pat. No. 3,013,054, U.S. Pat. No. 2,848,470, U.S. Pat. No. 3,317,549, U.S. Pat. No. 4,110,104, EP 48998, U.S. Pat. No. 3,285,925, U.S. Pat. No. 3,862,952, EP 60429, DE 3233089, U.S. Pat. No. 3,051,723 and the literature cited in the publications mentioned above.

Accordingly, the present invention provides a herbicide combination comprising herbicides from (A) and herbicides from (B), where (A) is one or more herbicides from the group consisting of 2-iodo-N-[(4-methoxy-6-methyl-1,3,5-triazin-2-yl)carbamoyl]benzenesulfonamide and compounds of the general formula (I)

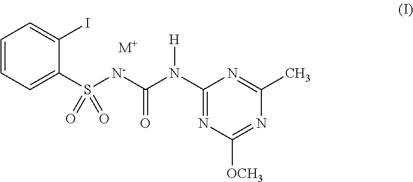

where
the cation (M⁺) is
(a) an alkali metal ion, preferably lithium, sodium, potassium, or
(b) an alkaline earth metal ion, preferably calcium or magnesium, or
(c) a transition metal ion, preferably manganese, copper, zinc or iron, or
(d) an ammonium ion where optionally one, two or three or all four hydrogen atoms are substituted by identical or different radicals from the group consisting of (C₁-C₄)-alkyl, hydroxy-(C₁-C₄)-alkyl, (C₃-C₆)-cycloalkyl, (C₁-C₄)-alkoxy-(C₁-C₄)-alkyl, hydroxy-(C₁-C₄)-alkoxy-(C₁-C₄)-alkyl, (C₁-C₆)-mercaptoalkyl, phenyl and benzyl,
where the radicals mentioned above are optionally substituted by one or more identical or different radicals from the group consisting of halogen, such as F, Cl, Br or I, nitro, cyano, azido, (C₁-C₆)-alkyl, (C₁-C₆)-haloalkyl, (C₃-C₆)-cycloalkyl, (C₁-C₆)-alkoxy, (C₁-C₆)-haloalkoxy and phenyl and where in each case two substituents at the nitrogen atom together optionally form an unsubstituted or substituted ring, or
(e) a phosphonium ion, or
(f) a sulfonium ion, preferably tri((C₁-C₄)-alkyl)sulfonium, or
(g) an oxonium ion, preferably tri((C₁-C₄)-alkyl)oxonium, or
(h) a saturated or unsaturated/aromatic nitrogenous heterocyclic ionic compound which has 1-10 carbon atoms in the ring system and is optionally mono- or polycondensed and/or substituted by (C₁-C₄)-alkyl,
   and

(B) is one or more herbicides from the group of the (het)arylcarboxylic acids consisting of:
the subgroup of the benzoic acids (subgroup 1), consisting of: dicamba [CAS RN 1918-00-9] (=B1-1); 2,3,6-TBA [CAS RN 50-31-7] (=B1-2);
the subgroup of the pyridinecarboxylic acids (subgroup 2), consisting of: clopyralid [CAS RN 1702-17-6] (=B2-1); fluoroxypyr [CAS RN 69377-81-7] (=B2-2); inabenfide [CAS RN 82211-24-3] (=B2-3); picloram [CAS RN 1918-02-1] (=B2-4); triclopyr [CAS RN 55335-06-3] (=B2-5);
the subgroup of the quinolonecarboxylic acids (subgroup 3), consisting of: quinclorac [CAS RN 84087-01-4] (=B3-1); quinmerac [CAS RN 90717-03-6] (=B3-2);
the subgroup of the indolylcarboxylic acids (subgroup 4), consisting of: indol-3-ylacetic acid [CAS RN 87-51-4] (=B4-1); 4-indol-3-ylbutyric acid [CAS RN 133-32-4] (=B4-2);
the subgroup of the naphthyl(oxy)carboxylic acids (subgroup 5), consisting of: 2-(1-naphthyl)acetamide [CAS RN 86-86-2] (=B5-1); 1-naphthylacetic acid [CAS RN 86-87-3] (=B5-2); 2-naphthyloxyacetic acid [CAS RN 120-23-0] (=B5-3);
the subgroup of the pyrimidinecarboxylic acids (subgroup 6), consisting of: aminocyclopyrachlor [CAS RN 858956-08-8] (=B6-1).

The “CAS RN” stated in square brackets after the names (common names) mentioned under group B corresponds to the “chemical abstract service registry number”, a customary reference number which allows the substances named to be classified unambiguously, since the “CAS RN” distinguishes, inter alia, between isomers including stereoisomers.

Preferred herbicides (A) are 2-iodo-N-[(4-methoxy-6-methyl-1,3,5-triazin-2-yl)carbamoyl]benzenesulfonamide and compounds of the formula (I) in which the cation (M⁺) is
(a) an alkali metal ion, preferably lithium, sodium, potassium, or
(b) an alkaline earth metal ion, preferably calcium or magnesium, or
(c) a transition metal ion, preferably manganese, copper, zinc or iron, or
(d) an ammonium ion where optionally one, two, three or all four hydrogen atoms are substituted by identical or different radicals from the group consisting of (C₁-C₄)-alkyl, hydroxy-(C₁-C₄)-alkyl, (C₃-C₄)-cycloalkyl, (C₁-C₂)-alkoxy-(C₁-C₂)-alkyl, hydroxy-(C₁-C₂)-alkoxy-(C₁-C₂)-alkyl, (C₁-C₂)-mercaptoalkyl, phenyl and benzyl, where the radicals mentioned above are optionally substituted by one or more identical or different radicals from the group consisting of halogen, such as F, Cl, Br or I, nitro, cyano, azido, (C₁-C₂)-alkyl, (C₁-C₂)-haloalkyl, (C₃-C₄)-cycloalkyl, (C₁-C₂)-alkoxy, (C₁-C₂)-haloalkoxy and phenyl, and where in each case two substituents at the nitrogen atom together optionally form an unsubstituted or substituted ring, or
(e) a quaternary phosphonium ion, preferably tetra-((C₁-C₄)-alkyl)phosphonium and tetraphenylphosphonium, where the (C₁-C₄)-alkyl radicals and the phenyl radicals are optionally mono- or polysubstituted by identical or different radicals from the group consisting of halogen, such as F, Cl, Br or I, (C₁-C₂)-alkyl, (C₁-C₂)-haloalkyl, (C₃-C₄)-cycloalkyl, (C₁-C₂)-alkoxy, (C₁-C₂)-haloalkoxy, or
(f) a tertiary sulfonium ion, preferably tri((C₁-C₄)-alkyl)sulfonium or triphenylsulfonium, where the (C₁-C₄)-alkyl radicals and the phenyl radicals are optionally mono- or polysubstituted by identical or different radicals from the group consisting of halogen, such as F, Cl, Br or I, (C₁-C₂)-alkyl, (C₁-C₂)-haloalkyl, (C₃-C₄)-cycloalkyl, (C₁-C₂)-alkoxy, (C₁-C₂)-haloalkoxy, or
(g) a tertiary oxonium ion, preferably tri((C₁-C₄)-alkyl)oxonium, where the (C₁-C₄)-alkyl radicals are optionally mono- or polysubstituted by identical or different radicals from the group consisting of halogen, such as F, Cl, Br or I, (C₁-C₂)-alkyl, (C₁-C₂)-haloalkyl, (C₃-C₄)-cycloalkyl, (C₁-C₂)-alkoxy, (C₁-C₂)-haloalkoxy, or
(h) a cation from the group of the following heterocyclic compounds, such as, for example, pyridine, quinoline, 2-methylpyridine, 3-methylpyridine, 4-methylpyridine, 2,4-dimethylpyridine, 2,5-dimethylpyridine, 2,6-dimethylpyridine, 5-ethyl-2-methylpyridine, piperidine, pyrrolidine, morpholine, thiomorpholine, pyrrole, imidazole, 1,5-diazabicyclo[4.3.0]non-5-ene (DBN), 1,8-diazabicyclo[5.4.0]undec-7-ene (DBU).

The hydrocarbon radicals mentioned in the radical definitions, such as alkyl, alkenyl or alkynyl, also in combinations with heteroatoms, such as an alkoxy, alkylthio, haloalkyl or alkylamino, are straight-chain or branched, even if this is not explicitly mentioned.

Examples of preferred compounds used as herbicide (A) are 2-iodo-N-[(4-methoxy-6-methyl-1,3,5-triazin-2-yl)carbamoyl]benzenesulfonamide (A-0) and the compounds of the formula (I) listed in table A below (i.e. the compounds (A-1 to A-35)).

TABLE A
Compounds of the general formula (I), where M⁺
denotes the respective salt of the compound
(I)

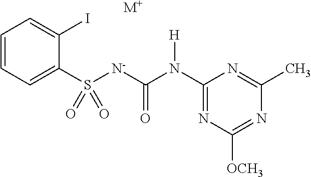

| Compound | M⁺ |
|---|---|
| A-1 | lithium |
| A-2 | sodium |
| A-3 | potassium |
| A-4 | magnesium |
| A-5 | calcium |
| A-6 | ammonium |
| A-7 | methylammonium |
| A-8 | dimethylammonium |
| A-9 | tetramethylammonium |
| A-10 | ethylammonium |
| A-11 | diethylammonium |
| A-12 | tetraethylammonium |
| A-13 | propylammonium |
| A-14 | tetrapropylammonium |
| A-15 | isopropylammonium |
| A-16 | diisopropylammonium |
| A-17 | butylammonium |
| A-18 | tetrabutylammonium |
| A-19 | (2-hydroxyeth-1-yl)ammonium |
| A-20 | bis-N,N-(2-hydroxyeth-1-yl)ammonium |
| A-21 | tris-N,N,N-(2-hydroxyeth-1-yl)ammonium |
| A-22 | 1-phenylethylammonium |
| A-23 | 2-phenylethylammonium |
| A-24 | trimethylsulfonium |
| A-25 | trimethyloxonium |
| A-26 | pyridinium |
| A-27 | 2-methylpyridinium |
| A-28 | 4-methylpyridinium |
| A-29 | 2,4-dimethylpyridinium |
| A-30 | 2,6-dimethylpyridinium |
| A-31 | piperidinium |
| A-32 | imidazolium |
| A-33 | morpholinium |
| A-34 | 1,5-diazabicyclo[4.3.0]non-7-enium |
| A-35 | 1,8-diazabicyclo[5.4.0]undec-7-enium |

Particularly preferred herbicides (A) are 2-iodo-N-[(4-methoxy-6-methyl-1,3,5-triazin-2-yl)carbamoyl]benzenesulfonamide and compounds of the formula (I) in which the cation (M⁺) is

a sodium ion, a potassium ion, a lithium ion, a magnesium ion, a calcium ion, an NH₄⁺ ion, a (2-hydroxyeth-1-yl)ammonium ion, a bis-N,N-(2-hydroxyeth-1-yl)ammonium ion, a tris-N,N,N-(2-hydroxyeth-1-yl)ammonium ion, a methyl-ammonium ion, a dimethylammonium ion, a trimethylammonium ion, a tetramethyl-ammonium ion, an ethylammonium ion, a diethylammonium ion, a triethylammonium ion, a tetraethylammonium ion, an isopropylammonium ion, a diisopropylammonium ion, a tetrapropylammonium ion, a tetrabutylammonium ion, a 2-(2-hydroxyeth-1-oxy)eth-1-ylammonium ion, a di(2-hydroxyeth-1-yl)ammonium ion, a trimethylbenzyl-ammonium ion, a tri((C₁-C₄)-alkyl)sulfonium ion, or a tri((C₁-C₄)-alkyl)oxonium ion, a benzylammonium ion, a 1-phenylethylammonium ion, a 2-phenylethylammonium ion, a diisopropylethylammonium ion, a pyridinium ion, a piperidinium ion, an imidazolium ion, a morpholinium ion, a 1,8-diazabicyclo[5.4.0]undec-7-enium ion.

Particularly preferred herbicides (A) are 2-iodo-N-[(4-methoxy-6-methyl-1,3,5-triazin-2-yl)carbamoyl]benzenesulfonamide and compounds of the formula (I) in which the cation (M⁺) is a sodium ion, a potassium ion, a magnesium ion, a calcium ion or an NH₄⁺ ion.

Particularly preferred herbicides (A) are likewise 2-iodo-N-[(4-methoxy-6-methyl-1,3,5-triazin-2-yl)carbamoyl]benzenesulfonamide and compounds of the formula (I) in which the cation (M⁺) is a sodium ion, a potassium ion or an NH₄⁺ ion.

Compounds which are preferred as herbicide (B) are:

dicamba [CAS RN 1918-00-9] (=B1-1); clopyralid [CAS RN 1702-17-6] (=B2-1); fluoroxypyr [CAS RN 69377-81-7] (=B2-2); picloram [CAS RN 1918-02-1] (=B2-4); triclopyr [CAS RN 55335-06-3] (=B2-5); quinclorac [CAS RN 84087-01-04] (=B3-1); aminocyclopyrachlor [CAS RN 858956-08-8] (=B6-1).

Depending on the type and the attachment of the substituents, the herbicides (A) and (B) can be present as stereoisomers. The formula (I) embraces all possible stereoisomers defined by their specific spatial form, such as enantiomers, diastereomers, Z and E isomers.

If, for example, one or more alkenyl groups are present, diastereomers (Z and E isomers) may exist. If, for example, one or more asymmetrically substituted carbon atoms are present, enantiomers and diastereomers may exist. From the mixtures produced in the preparation, stereoisomers can be obtained by customary separation methods, for example by chromatographic separation procedures. Stereoisomers can also be prepared selectively by using stereoselective reactions and employing optically active starting materials and/or auxiliaries. Accordingly, the invention also relates to all stereoisomers of the herbicides (A) and/or (B) no longer shown in their specific stereo form, and to their mixtures.

Additionally, the herbicide combinations according to the invention may comprise further components, for example agrochemically active compounds of a different type and/or the formulation auxiliaries and/or additives customary in crop protection, or may be used together with these.

The preparation of salts of 2-iodo-N-[(4-methoxy-6-methyl-1,3,5-triazin-2-yl)carbamoyl]benzenesulfonamide, in particular of compounds of the general formula (I), is known in the prior art; cf. also the European patent application EP 07020807.9, filed on Oct. 24, 2007, from Bayer CropScience AG having the title “Salts of 2-iodo-N-[(4-methoxy-6-methyl-1,3,5-triazin-2-yl)carbamoyl]benzenesulfonamide, processes for their preparation and their use as herbicides and plant growth regulators”.

In a preferred embodiment, the herbicide combinations according to the invention comprise effective amounts of the herbicides (A) and (B) and/or have synergistic actions. The synergistic actions can be observed, for example, when applying the herbicides (A) and (B) together, for example as a coformulation or as a tank mix; however, they can also be observed when the active compounds are applied at different times (splitting). It is also possible to apply the herbicides or the herbicide combinations in a plurality of portions (sequential application), for example pre-emergence applications followed by post-emergence applications or early post-emergence applications followed by medium or late post-emergence applications. Preference is given here to the joint or almost simultaneous application of the herbicides (A) and (B) of the combination in question.

The synergistic effects permit a reduction of the application rates of the individual herbicides, a higher efficacy at the same application rate, the control of species which were as yet uncontrolled (gaps), control of species which are tolerant or resistant to individual herbicides or to a number of herbicides, an extension of the period of application and/or a reduction in the number of individual applications required and—as a result for the user—weed control systems which are more advantageous economically and ecologically.

For example, the combinations according to the invention of herbicides (A)+(B) allow the activity to be enhanced synergistically in a manner which, by far and in an unexpected manner, exceeds the activities which can be achieved using the individual herbicides (A) and (B).

The formula (I) mentioned embraces all stereoisomers and their mixtures, in particular also racemic mixtures, and—if enantiomers are possible—the respective enantiomer which is biologically active.

The herbicides of group (A) inhibit the enzyme acetolactate synthase (ALS) and thus protein biosynthesis in plants. The application rate of the herbicides (A) can vary within a wide range, for example between 0.001 g and 1500 g of AS/ha (hereinbelow, AS/ha means “active substance per hectare”=based on 100% pure active compound). Applied at application rates of from 0.001 g to 1500 g of AS/ha, the herbicides (A), preferably the compounds A-0 to A-35, control, when used by the pre- and post-emergence method, a relatively wide spectrum of harmful plants, for example of annual and perennial mono- or dicotyledonous weeds, and also of unwanted crop plants. For the combinations according to the invention, the application rates are generally lower, for example in the range of from 0.01 g to 1000 g of AS/ha, preferably from 0.1 g to 500 g of AS/ha, particularly preferably from 0.5 g to 250 g of AS/ha.

The herbicides of group (B) have an effect, for example, on auxin metabolism, gibberillin biosynthesis, cellulose biosynthesis or act as plant growth factor, and they are suitable both for pre-emergence and post-emergence application. The application rate of the herbicides (B) can vary within a wide range, for example between 1 g and 15 000 g of AS/ha (hereinbelow, AS/ha means “active substance per hectare”=based on 100% pure active compound). Applied at applications rates of from 1 g to 15 000 g of AS/ha, the herbicides (B), preferably the compounds B1-1 to B6-1, control, when used by the pre- and post-emergence method, a relatively wide spectrum of harmful plants, for example of annual and perennial mono- or dicotyledonous weeds, and also of unwanted crop plants. For the combinations according to the invention, the application rates of herbicides of group (B) are generally lower, for example in the range of from 1 g to 1000 g of AS/ha, preferably from 0.3 g to 10 000 g of AS/ha, particularly preferably from 0.3 g to 5000 g of AS/ha.

Preference is given to herbicide combinations of one or more herbicides (A) and one or more herbicides (B). More preference is given to combinations of herbicides (A) with one or more herbicides (B) according to the scheme:

### (A-0)+(B1-1), (A-0)+(B1-2), (A-0)+(B5-3), (A-1)+(B1-1), (A-1)+(B1-2), (A-1)+(B5-3), (A-35)+(B1-1), (A-35)+(B1-2), (A-35)+(B6-1).

Here, combinations additionally comprising one or more further agrochemically active compounds which differ from the herbicides (A) and (B) but also act as selective herbicides are likewise in accordance with the invention.

For combinations of three or more active compounds, the preferred conditions illustrated below in particular for two-component combinations according to the invention primarily also apply, provided they comprise the two-component combinations according to the invention.

Ranges of suitable ratios of the compounds (A) and (B) can be found, for example, by looking at the application rates mentioned for the individual compounds. In the combinations according to the invention, the application rates can generally be reduced. Preferred mixing ratios (A):(B), for the combinations according to the invention are listed below:

(A):(B)=1000:1 to 1:20 000, preferably from 250:1 to 1:15 000, particularly preferably from 50:1 to 1:10 000.

Of particular interest is the use of herbicidal compositions having a content of the following compounds (A)+(B):

(A-0)+(81-1), (A-0)+(81-2), (A-0)+(B2-1), (A-0)+(B2-2), (A-0)+(B2-3), (A-0)+(B2-4), (A-0)+(B2-5), (A-0)+(B3-1), (A-0)+(B3-2), (A-0)+(B4-1), (A-0)+(B4-2), (A-0)+(B5-1), (A-0)+(B5-2), (A-0)+(B5-3); (A-0)+(86-1);

(A-1)+(B1-1), (A-1)+(B1-2), (A-1)+(B2-1), (A-1)+(B2-2), (A-1)+(82-3), (A-1)+(B2-4), (A-1)+(B2-5), (A-1)+(B3-1), (A-1)+(B3-2), (A-1)+(B4-1), (A-1)+(B4-2), (A-1)+(B5-1), (A-1)+(B5-2), (A-1)+(85-3); (A-1)+(B6-1);

(A-2)+(B1-1), (A-2)+(B1-2), (A-2)+(32-1), (A-2)+(B2-2), (A-2)+(B2-3), (A-2)+(B2-4), (A-2)+(B2-5), (A-2)+(B3-1), (A-2)+(B3-2), (A-2)+(B4-1), (A-2)+(B4-2), (A-2)+(B5-1), (A-2)+(B5-2), (A-2)+(B5-3); (A-2)+(B6-1);

(A-3)+(B1-1), (A-3)+(B1-2), (A-3)+(B2-1), (A-3)+(B2-2), (A-3)+(B2-3), (A-3)+(B2-4), (A-3)+(B2-5), (A-3)+(B3-1), (A-3)+(B3-2), (A-3)+(B4-1), (A-3)+(B4-2), (A-3)+(B5-1), (A-3)+(B5-2), (A-3)+(B5-3); (A-3)+(B6-1);

(A-4)+(B1-1), (A-4)+(B1-2), (A-4)+(B2-1), (A-4)+(B2-2), (A-4)+(B2-3), (A-4)+(B2-4), (A-4)+(B2-5), (A-4)+(B3-1), (A-4)+(B3-2), (A-4)+(B4-1), (A-4)+(B4-2), (A-4)+(B5-1), (A-4)+(B5-2), (A-4)+(B5-3); (A-4)+(B6-1);

(A-5)+(B1-1), (A-5)+(B1-2), (A-5)+(B2-1), (A-5)+(B2-2), (A-5)+(B2-3), (A-5)+(B2-4), (A-5)+(B2-5), (A-5)+(B3-1), (A-5)+(B3-2), (A-5)+(B4-1), (A-5)+(B4-2), (A-5)+(B5-1), (A-5)+(B5-2), (A-5)+(B5-3); (A-5)+(B6-1);

(A-6)+(B1-1), (A-6)+(B1-2), (A-6)+(B2-1), (A-6)+(B2-2), (A-6)+(B2-3), (A-6)+(B2-4), (A-6)+(B2-5), (A-6)+(B3-1), (A-6)+(B3-2), (A-6)+(B4-1), (A-6)+(B4-2), (A-6)+(B5-1), (A-6)+(B5-2), (A-6)+(B5-3); (A-6)+(B6-1);

(A-7)+(B1-1), (A-7)+(B1-2), (A-7)+(B2-1), (A-7)+(B2-2), (A-7)+(B2-3), (A-7)+(B2-4), (A-7)+(B2-5), (A-7)+(B3-1), (A-7)+(B3-2), (A-7)+(B4-1), (A-7)+(B4-2), (A-7)+(B5-1), (A-7)+(B5-2), (A-7)+(B5-3); (A-7)+(B6-1);

(A-8)+(B1-1), (A-8)+(B1-2), (A-8)+(B2-1), (A-8)+(B2-2), (A-8)+(B2-3), (A-8)+(B2-4), (A-8)+(B2-5), (A-8)+(B3-1), (A-8)+(B3-2), (A-8)+(B4-1), (A-8)+(B4-2), +(B5-1), (A-8)+(B5-2), (A-8)+(B5-3); (A-8)+(B6-1);

(A-9)+(B1-1), (A-9)+(B1-2), (A-9)+(B2-1), (A-9)+(B2-2), (A-9)+(B2-3), (A-9)+(B2-4), (A-9)+(B2-5), (A-9)+(B3-1), (A-9)+(B3-2), (A-9)+(B4-1), (A-9)+(B4-2), (A-9)+(B5-1), (A-9)+(B5-2), (A-9)+(B5-3); (A-9)+(B6-1);

(A-10)+(B1-1), (A-10)+(B1-2), (A-10)+(B2-1), (A-10)+(B2-2), (A-10)+(B2-3), (A-10)+(B2-4), (A-10)+(B2-5), (A-10)+(B3-1), (A-10)+(B3-2), (A-10)+(B4-1), (A-10)+(B4-2), (A-10)+(B5-1), (A-10)+(B5-2), (A-10)+(B5-3); (A-10)+(B6-1);

(A-11)+(B1-1), (A-11)+(B1-2), (A-11)+(B2-1), (A-11)+(B2-2), (A-11)+(B2-3), (A-11)+(B2-4), (A-11)+(B2-5), (A-11)+(B3-1), (A-11)+(B3-2), (A-11)+(B4-1), (A-11)+(B4-2), (A-11)+(B5-1), (A-11)+(B5-2), (A-11)+(B5-3); (A-11)+(B6-1);

(A-12)+(B1-1), (A-12)+(B1-2), (A-12)+(B2-1), (A-12)+(B2-2), (A-12)+(B2-3), (A-12)+(B2-4), (A-12)+(B2-5), (A-12)+(B3-1), (A-12)+(B3-2), (A-12)+(B4-1), (A-12)+(B4-2), (A-12)+(B5-1), (A-12)+(B5-2), (A-12)+(B5-3); (A-12)+(B6-1);

(A-13)+(B1-1), (A-13)+(B1-2), (A-13) (32-1), (A-13)+(B2-2), (A-13)+(B2-3), (A-13)+(B2.4), (A-13)+(B2-5), (A-13)+(B3-1), (A-13)+(B3-2), (A-13)+(B4-1), (A-13)+(B4-2), (A-13)+(B5-1), (A-13)+(B5-2), (A-13)+(B5-3); (A-13)+(B6-1);

(A-14)+(B1-1), (A-14)+(B1-2), (A-14)+(B2-1), (A-14)+(B2-2), (A-14)+(B2-3), (A-14)+(B2-4), (A-14)+(B2-5), (A-14)+(B3-1), (A-14)+(B3-2), (A-14)+(B4-1), (A-14)+(B4-2), (A-14)+(B5-1), (A-14)+(B5-2), (A-14)+(B5-3); (A-14)+(B6-1);

(A-15)+(B1-1), (A-15)+(B1-2), (A-15)+(B2-1), (A-15)+(B2-2), (A-15)+(B2-3), (A-15)+(B2-4), (A-15)+(B2-5), (A-15)+(B3-1), (A-15)+(B3-2), (A-15)+(B4-1), (A-15)+(B4-2), (A-15)+(B5-1), (A-15)+(B5-2), (A-15)+(B5-3); (A-15)+(B6-1);

(A-16)+(B1-1), (A-16)+(B1-2), (A-16)+(B2-1), (A-16)+(B2-2), (A-16)+(B2-3), (A-16)+(B2-4), (A-16)+(B2-5), (A-16)+(B3-1), (A-16)+(B3-2), (A-16)+(B4-1), (A-16)+(B4-2), (A-16)+(B5-1), (A-16)+(B5-2), (A-16)+(B5-3); (A-16)+(B6-1);

(A-17)+(B1-1), (A-17)+(B1-2), (A-17)+(B2-1), (A-17)+(B2-2), (A-17)+(B2-3), (A-17)+(B2-4), (A-17)+(92-5), (A-17)+(B3-1), (A-17)+(B3-2), (A-17)+(B4-1), (A-17)+(B4-2), (A-17)+(B5-1), (A-17)+(B5-2), (A-17)+(B5-3); (A-17)+(B6-1);

(A-18)+(B1-1), (A-18)+(B1-2), (A-18)+(B2-1), (A-18)+(B2-2), (A-18)+(B2-3), (A-18)+(B2-4), (A-18)+(B2-5), (A-18)+(B3-1), (A-18)+(B3-2), (A-18)+(B4-1), (A-18)+(B4-2), (A-18)+(B5-1), (A-18)+(B5-2), (A-18)+(B5-3); (A-18)+(B6-1);

(A-19)+(B1-1), (A-19)+(B1-2), (A-19)+(B2-1), (A-19)+(B2-2), (A-19)+(B2-3), (A-19)+(B2-4), (A-19)+(B2-5), (A-19)+(B3-1), (A-19)+(B3-2), (A-19)+(B4-1), (A-19)+(B4-2), (A-19)+(B5-1), (A-19)+(B5-2), (A-19)+(B5-3); (A-19)+(B6-1);

(A-20)+(B1-1), (A-20)+(B1-2), (A-20)+(B2-1), (A-20)+(B2-2), (A-20)+(B2-3), (A-20)+(B2-4), (A-20)+(B2-5), (A-20)+(B3-1), (A-20)+(B3-2), (A-20)+(B4-1), (A-20)+(B4-2), (A-20)+(B5-1), (A-20)+(B5-2), (A-20)+(B5-3); (A-20)+(B6-1);

(A-21)+(B1-1), (A-21)+(B1-2), (A-21)+(B2-1), (A-21)+(B2-2), (A-21)+(B2-3), (A-21)+(B2-4), (A-21)+(B2-5), (A-21)+(B3-1), (A-21)+(B3-2), (A-21)+(B4-1), (A-21)+(B4-2), (A-21)+(B5-1), (A-21)+(B5-2), (A-21)+(B5-3); (A-21)+(B6-1);

(A-22)+(B1-1), (A-22)+(B1-2), (A-22)+(B2-1), (A-22)+(B2-2), (A-22)+(B2-3), (A-22)+(B2-4), (A-22)+(B2-5), (A-22)+(B3-1), (A-22)+(B3-2), (A-22)+(B4-1), (A-22)+(B4-2), (A-22)+(B5-1), (A-22)+(B5-2), (A-22)+(B5-3); (A-22)+(B6-1);

(A-23)+(B1-1), (A-23)+(B1-2), (A-23)+(B2-1), (A-23)+(B2-2), (A-23)+(B2-3), (A-23)+(B2-4), (A-23)+(B2-5), (A-23)+(B3-1), (A-23)+(B3-2), (A-23)+(B4-1), (A-23)+(B4-2), (A-23)+(B5-1), (A-23)+(B5-2), (A-23)+(B5-3); (A-23)+(B6-1);

(A-24)+(B1-1), (A-24)+(B1-2), (A-24)+(B2-1), (A-24)+(B2-2), (A-24)+(B2-3), (A-24)+(B2-4), (A-24)+(B2-5), (A-24)+(B3-1), (A-24)+(B3-2), (A-24)+(B4-1), (A-24)+(B4-2), (A-24)+(B5-1), (A-24)+(B5-2), (A-24)+(B5-3); (A-24)+(B6-1);

(A-25)+(B1-1), (A-25)+(B1-2), (A-25)+(B2-1), (A-25)+(B2-2), (A-25)+(B2-3), (A-25)+(B2-4), (A-25)+(B2-5), (A-25)+(B3-1), (A-25)+(B3-2), (A-25)+(B4-1), (A-25)+(B4-2), (A-25)+(B5-1), (A-25)+(B5-2), (A-25)+(B5-3); (A-25)+(B6-1);

(A-26)+(B1-1), (A-26)+(B1-2), (A-26)+(B2-1), (A-26)+(B2-2), (A-26)+(B2-3), (A-26)+(B2-4), (A-26)+(B2-5), (A-26)+(B3-1), (A-26)+(B3-2), (A-26)+(B4-1), (A-26)+(B4-2), (A-26)+(B5-1), (A-26)+(B5-2), (A-26)+(B5-3); (A-26)+(B6-1);

(A-27)+(B1-1), (A-27)+(B1-2), (A-27)+(B2-1), (A-27)+(B2-2), (A-27)+(B2-3), (A-27)+(B2-4), (A-27)+(B2-5), (A-27)+(B3-1), (A-27)+(B3-2), (A-27)+(B4-1), (A-27)+(B4-2), (A-27)+(B5-1), (A-27)+(B5-2), (A-27)+(B5-3); (A-27)+(B6-1);

(A-28)+(B1-1), (A-28)+(B1-2), (A-28)+(B2-1), (A-28)+(B2-2), (A-28)+(B2-3), (A-28)+(B2-4), (A-28)+(B2-5), (A-28)+(B3-1), (A-28)+(B3-2), (A-28)+(B4-1), (A-28)+(B4-2), (A-28)+(B5-1), (A-28)+(B5-2), (A-28)+(B5-3); (A-28)+(B6-1);

(A-29)+(B1-1), (A-29)+(B1-2), (A-29)+(B2-1), (A-29)+(B2-2), (A-29)+(B2-3), (A-29)+(B2-4), (A-29)+(B2-5), (A-29)+(B3-1), (A-29)+(B3-2), (A-29)+(B4-1), (A-29)+(B4-2), (A-29)+(B5-1), (A-29)+(B5-2), (A-29)+(B5-3); (A-29)+(B6-1);

(A-30)+(B1-1), (A-30)+(B1-2), (A-30)+(B2-1), (A-30)+(B2-2), (A-30)+(B2-3), (A-30)+(B2-4), (A-30)+(B2-5), (A-30)+(B3-1), (A-30)+(B3-2), (A-30)+(B4-1), (A-30)+(B4-2), (A-30)+(B5-1), (A-30)+(B5-2), (A-30)+(B5-3); (A-30)+(B6-1);

(A-31)+(B1-1), (A-31)+(B1-2), (A-31)+(B2-1), (A-31)+(B2-2), (A-31)+(B2-3), (A-31)+(B2-4), (A-31)+(B2-5), (A-31)+(B3-1), (A-31)+(B3-2), (A-31)+(B4-1), (A-31)+(B4-2), (A-31)+(B5-1), (A-31)+(B5-2), (A-31)+(B5-3); (A-31)+(B6-1);

(A-32)+(B1-1), (A-32)+(B1-2), (A-32)+(B2-1), (A-32)+(B2-2), (A-32)+(B2-3), (A-32)+(B2-4), (A-32)+(B2-5), (A-32)+(B3-1), (A-32)+(B3-2), (A-32)+(B4-1), (A-32)+(B4-2), (A-32)+(B5-1), (A-32)+(B5-2), (A-32)+(B5-3); (A-32)+(B6-1);

(A-33)+(B1-1), (A-33)+(B1-2), (A-33)+(B2-1), (A-33)+(B2-2), (A-33)+(B2-3), (A-33)+(B2-4), (A-33)+(B2-5), (A-33)+(B3-1), (A-33)+(B3-2), (A-33)+(B4-1), (A-33)+(B4-2), (A-33)+(B5-1), (A-33)+(B5-2), (A-33)+(B5-3); (A-33)+(B6-1);

(A-34)+(B1-1), (A-34)+(B1-2), (A-34)+(B2-1), (A-34)+(B2-2), (A-34)+(B2-3), (A-34)+(B2-4), (A-34)+(B2-5), (A-34)+(B3-1), (A-34)+(B3-2), (A-34)+(B4-1), (A-34)+(B4-2), (A-34)+(B5-1), (A-34)+(B5-2), (A-34)+(B5-3); (A-34)+(B6-1);

(A-35)+(B1-1), (A-35)+(B1-2), (A-35)+(B2-1), (A-35)+(B2-2), (A-35)+(B2-3), (A-35)+(B2-4), (A-35)+(B2-5), (A-35)+(B3-1), (A-35)+(B3-2), (A-35)+(B4-1), (A-35)+(B4-2), (A-35)+(B5-1), (A-35)+(B5-2), (A-35)+(B5-3); (A-35)+(B6-1);

The herbicide combinations according to the invention may furthermore comprise various agrochemically active compounds, for example from the group of the safeners, fungicides, insecticides, herbicides which differ structurally from the herbicides (A) and (B) and plant growth regulators, or from the group of the formulation auxiliaries and additives customary in crop protection.

Thus, suitable further herbicides are, for example, the following herbicides which differ structurally from the herbicides (A) and (B), preferably herbicidally active compounds whose action is based on inhibition of, for example, acetolactate synthase, acetyl coenzyme A carboxylase, PS I, PS II, HPPDO, phytoene desaturase, protoporphyrinogen oxidase, glutamine synthetase, cellulose biosynthesis, 5-enolpyruvylshikimate 3-phosphate synthetase, as described, for example, in Weed Research 26, 441-445 (1986), or “The Pesticide Manual”, 13th edition, The British Crop Protection Council, 2003, or 14^{th} edition 2006/2007, or in the corresponding “e-Pesticide Manual”, Version 4 (2006), in each case published by the British Crop Protection Council, (hereinbelow in short also “PM”), and in the literature cited therein. Lists of common names are also available in “The Compendium of Pesticide Common Names” on the internet. Herbicides known from the literature, which can be combined with 2-iodo-N-[(4-methoxy-6-methyl-1,3,5-triazin-2-yl)carbamoyl]benzenesulfonamide and the compounds of the formula (I), are, for example, the active compounds listed below: (note: the herbicides are referred to either by the “common name” in accordance with the International Organization for Standardization (ISO) or by the chemical name, together where appropriate with a customary code number, and in each case include all use forms, such as acids, salts, esters and isomers, such as stereoisomers and optical isomers, in particular the commercial form or the commercial forms, unless the context indicates otherwise. Sulfonamides, such as sulfonylureas, also include salts formed by exchanging a hydrogen atom at the sulfonamide group for a cation. The citation given is of one use form and in some cases of two or more use forms): acetochlor; acibenzolar-S-methyl; acifluorfen(-sodium); aclonifen; AD-67; AKH 7088, i.e. [[[1-[5-[2-chloro-4-(trifluoromethyl)phenoxy]-2-nitrophenyl]-2-methoxyethylidene]amino]oxy]acetic acid and methyl [[[1-[5-[2-chloro-4-(trifluoromethyl)phenoxy]-2-nitrophenyl]-2-methoxyethylidene]amino]oxy]acetate; alachlor; ametryn; amicarbazone, amidochlor, amidosulfuron; aminopyralid; amitrol; ammonium pelargonate; AMS, i.e. ammonium sulfamate; ancimidol; anilofos; asulam; atrazine; aviglycine; azafenidin, azimsulfuron (DPX-A8947); aziprotryn; barban; BAS 516H, i.e. 5-fluoro-2-phenyl-4H-3,1-benzoxazin-4-one; beflubutamid (UBH-509), benazolin(-ethyl); bencarbazone; benfluralin; benfuresate; bensulfuron(methyl); bensulide; bentazone; benzfendizone; benzobicyclon, benzofenap; benzofluor; benzoylprop(-ethyl); benzthiazuron; bilanaphos; bifenox; bispyribac(-sodium) (KIH-2023); borax; bromacil; bromobutide; bromofenoxim; bromoxynil; bromuron; buminafos; busoxinone; butachlor; butafenacil; butamifos; butenachlor (KH-218); buthidazole; butralin; butylate; cafenstrole (CH-900); caloxydim; carbetamide; carfentrazone(-ethyl); catechin; CDAA, i.e. 2-chloro-N,N-di-2-propenylacetamide; CDEC, i.e. 2-chloroallyl diethyldithiocarbamate; chlormesulon; chlomethoxyfen; chloramben; chlorazifop-butyl; chlorbromuron; chlorbufam; chlorfenac; chlorfenprop; chlorflurecol(-methyl); chlorflurenol(-methyl); chloridazon; chlorimuron(-ethyl); chlormequat(chloride); chlornitrofen; chlorophthalim (MK-616); chlorotoluron; chloroxuron; chlorpropham; chlorsulfuron; chlorthal-dimethyl; chlorthiamid; chlortoluron; cinidon(-methyl and -ethyl); cinmethylin; cinosulfuron; clefoxydim; clethodim; clodinafop and its ester derivatives (for example clodinafop-propargyl); clofencet; clomazone; clomeprop; cloprop; cloproxydim; clopyrasulfuron(-methyl); cloransulam(-methyl); cumyluron (JC 940); cyanamide; cyanazine; cycloate; cyclosulfamuron (AC 104); cycluron; cyhalofop and its ester derivatives (for example the butyl ester, DEN-112); cyperquat; cyprazine; cyprazole; daimuron; 2,4-D; 2,4-DB; dalapon; daminozide; dazomet; n-decanol; desmedipham; desmetryn; di-allate; dichlobenil; dichlormid; dichlorprop(-P) salts; diclofop and its esters, such as diclofop-methyl; diclofop-P(-methyl); diclosulam; diethatyl(-ethyl); difenoxuron; difenzoquat(-metilsulfate); diflufenican; diflufenzopyr(-sodium); dimefuron; dimepiperate; dimethachlor; dimethametryn; dimethazone; dimethenamid (SAN-582H); dimethenamid-P; dimethylarsinic acid; dimethipin; dimetrasulfuron; dimexyflam; dinitramine; dinoseb; dinoterb; diphenamid; dipropetryn; diquat salts; dithiopyr; diuron; DNOC; eglinazine-ethyl; EL 77, i.e. 5-cyano-1-(1,1-dimethylethyl)-N-methyl-1H-pyrazole-4-carboxamide; endothal; epoprodan; EPTC; esprocarb; ethalfluralin; ethametsulfuron-methyl; ethephon; ethidimuron; ethiozin; ethofumesate; ethoxyfen and its esters (for example ethyl ester, HN-252); ethoxysulfuron; etobenzanid (HW 52); F5231, i.e. N-[2-chloro-4-fluoro-5-[4-(3-fluoropropyl)-4,5-dihydro-5-oxo-1H-tetrazol-1-yl]phenyl]ethanesulfonamide; fenchlorazole(-ethyl); fenclorim; fenoprop; fenoxan, fenoxaprop and fenoxaprop-P and their esters, for example fenoxaprop-P-ethyl and fenoxaprop-ethyl; fenoxydim; fentrazamide; fenuron; ferrous sulfate; flamprop(-methyl or -isopropyl or -isopropyl-L); flamprop-M(-methyl or -isopropyl); flazasulfuron; floazulate (JV-485); florasulam; fluazifop and fluazifop-P and their esters, for example fluazifop-butyl and fluazifop-P-butyl; fluazolate; flucarbazone(-sodium); flucetosulfuron; fluchloralin; flufenacet; flufenpyr(-ethyl); flumetralin; flumetsulam; flumeturon; flumiclorac(-pentyl); flumioxazin (S-482); flumipropyn; fluometuron; fluorochloridone; fluorodifen; fluoroglycofen(-ethyl); flupoxam (KNW-739); flupropacil (UBIC-4243); flupropanoate; flupyrsulfuron(-methyl)(-sodium); flurenol(-butyl); fluridone; fluorochloridone; flurprimidol; flurtamone; fluthiacet(-methyl) (KIH-9201); fluthiamide; fluxofenim; fomesafen; foramsulfuron; forchlorfenuron; fosamine; furyloxyfen; gibberillic acid; glufosinate(-ammonium); glyphosate(-isopropylammonium); halosafen; halosulfuron(-methyl); haloxyfop and its ester; haloxyfop-P(═R-haloxyfop) and its ester; HC-252; hexazinone; HNPC-C9908, i.e. methyl 2-[[[[[4-methoxy-6-(methylthio)-2-pyrimidinyl]amino]carbonyl]amino]sulfonyl]benzoate; imazamethabenz(-methyl); imazamox; imazapic; imazapyr; imazaquin and salts, such as the ammonium salt; imazethapyr; imazosulfuron; indanofan; iodosulfuron-methyl(-sodium); ioxynil; isocarbamid; isopropalin; isoproturon; isouron; isoxaben; isoxachlortole; isoxaflutole; isoxapyrifop; karbutilate; lactofen; lenacil; linuron; maleic hydrazide (MH); MBTA; MCPA; MCPB; mecoprop(-P); mefenacet; mefluidide; mepiquat(-chloride); mesosulfuron(-methyl); metam; metamifop; metamitron; metazachlor; methabenzthiazuron; metham; methazole; methoxyphenone; methylarsonic acid; methylcyclopropene; methyldymron; methyl isothiocyanate; methabenzthiazuron; metobenzuron; metobromuron; (alpha-)metolachlor, metosulam (XRD 511); metoxuron; metribuzin; metsulfuron-methyl; molinate; monalide; monocarbamide dihydrogensulfate; monolinuron; monuron; monosulfuron; MT 128, i.e. 6-chloro-N-(3-chloro-2-propenyl)-5-methyl-N-phenyl-3-pyridazinamine; MT 5950, i.e. N-[3-chloro-4-(1-methylethyl)-phenyl]-2-methylpentanamide; naproanilide; napropamide; naptalam; NC 310, i.e. 4-(2,4-dichlorobenzoyl)-1-methyl-5-benzyloxypyrazole; neburon; nicosulfuron; nipyraclofen; nitralin; nitrofen; nitrophenolate mixture; nitrofluorfen; nonanoic acid; norflurazon; orbencarb; orthosulfamuron; oxabetrinil; oryzalin; oxadiargyl (RP-020630); oxadiazon; oxasulfuron; oxaziclomefone; oxyfluorfen; paclobutrazol; paraquat(-dichloride); pebulate; pelargonic acid; pendimethalin; penoxulam; pentachlorophenol; pentanochlor; pentoxazone; perfluidone; pethoxamid; phenisopham; phenmedipham; picolinafen; piperophos; piributicarb; pirifenop-butyl; pretilachlor; primisulfuron(-methyl); probenazole; procarbazone-(sodium); procyazine; prodiamine; profluralin; prohydrojasmon; proglinazine(-ethyl); prometon; prometryn; propachlor; propanil; propaquizafop and its esters; propazine; propham; propisochlor; propoxycarbazone(-sodium) (MKH-6561); propyzamide; prosulfalin; prosulfocarb; prosulfuron (CGA-152005); prynachlor; pyraclonil; pyraflufen(-ethyl) (ET-751); pyrasulfotole; pyrazolynate; pyrazon; pyrazosulfuron(-ethyl); pyrazoxyfen; pyribambenz-isopropyl (ZJ 0702); pyrimbambenz-propyl (ZJ 0273); pyribenzoxim; pyributicarb; pyridafol; pyridate; pyriftalid; pyriminobac(-methyl) (KIH-6127); pyrimisulfan (KIH-5996); pyrithiobac(-sodium) (KIH-2031); pyroxasulfone (KIH-485); pyroxofop and its esters (for example the propargyl ester); pyroxsulam; quinoclamine; quinofop and its ester derivatives, quizalofop and quizalofop-P and their ester derivatives for example quizalofop-ethyl; quizalofop-P-tefuryl and -ethyl; renriduron; rimsulfuron (DPX-E 9636); S 275, i.e. 2-[4-chloro-2-fluoro-5-(2-propynyloxy)phenyl]-4,5,6,7-tetrahydro-2H-indazole; secbumeton; siduron; simazine; simetryn; sintofen; SN 106279, i.e. 2-[[7-[2-chloro-4-(trifluoromethyl)phenoxy]-2-naphthalenyl]oxy]propanoic acid and methyl 2-[[7-[2-chloro-4-(trifluoro-methyl)phenoxy]-2-naphthalenyl]oxy]propanoate; sulfentrazone (FMC-97285, F-6285); sulfazuron; sulfometuron(-methyl); sulfosate (ICI-A0224); sulfosulfuron; TCA(-sodium); tebutam (GCP-5544); tebuthiuron; tecnacene; terbacil; terbucarb; terbuchlor; terbumeton; terbuthylazine; terbutryn; TFH 450, i.e. N,N-diethyl-3-[(2-ethyl-6-methylphenyl)sulfonyl]-1H-1,2,4-triazole-1-carboxamide; thenylchlor (NSK-850); thiafluamide, thiazafluoron; thiazopyr (Mon-13200); thidiazimin (SN-24085); thidiazuron; thiencarbazone(-methyl); thifensulfuron(-methyl); thiobencarb; Ti 35; tiocarbazil; topramezone; tri-allate; triasulfuron; triaziflam; triazofenamide; tribenuron(-methyl); tridiphane; trietazine; trifloxysulfuron(-sodium); trifluralin; triflusulfuron and esters (for example the methyl ester, DPX-66037); trimeturon; tritosulfuron; tsitodef; uniconazole; vernolate; WL 110547, i.e. 5-phenoxy-1-[3-(trifluoromethyl)phenyl]-1H-tetrazole; D-489; ET-751; KIH-218; KIH-485; KIH-509; KPP-300; LS 82-556; NC-324; NC-330; DPX-N8189; SC-0774; DOWCO-535; DK-8910; V-53482; PP-600; MBH-001; TH-547; SYN-523; IDH-100; SYP-249; HOK-201; IR-6396; MTB-951; NC-620.

Of particular interest is the selective control of harmful plants in crops of useful plants and ornamental plants. Although the herbicides (A) and (B) have already demonstrated very good to sufficient selectivity in a large number of crops, in principle, in some crops and in particular also in the case of mixtures with other, less selective herbicides, phytotoxicities on the crop plants may occur. In this respect, combinations of herbicides (A) and (B) comprising the herbicidally active compounds combined according to the invention and one or more safeners are of particular interest. The safeners, which are used in an antidotically effective amount, reduce the phytotoxic side effects of the herbicides/pesticides employed, for example in economically important crops, such as cereals (wheat, barley, rye, corn, rice, millet), sugarbeet, sugarcane, oilseed rape, cotton and soybeans, preferably cereals.

The safeners are preferably selected from the group consisting of:

A) compounds of the formula (S-I)

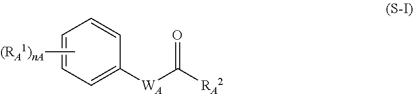

where the symbols and indices have the following meanings:
n_{A} is a natural number from 0 to 5, preferably from 0 to 3;
R_{A}¹ is halogen, (C₁-C₄)-alkyl, (C₁-C₄)-alkoxy, nitro or (C₁-C₄)-haloalkyl;
W_{A} is an unsubstituted or substituted divalent heterocyclic radical from the group consisting of partially unsaturated or aromatic five-membered heterocycles having 1 to 3 hetero ring atoms of the type N or O, where at least one nitrogen atom and at most one oxygen atom is present in the ring, preferably a radical from the group consisting of (W_{A}¹) to (W_{A}⁴),

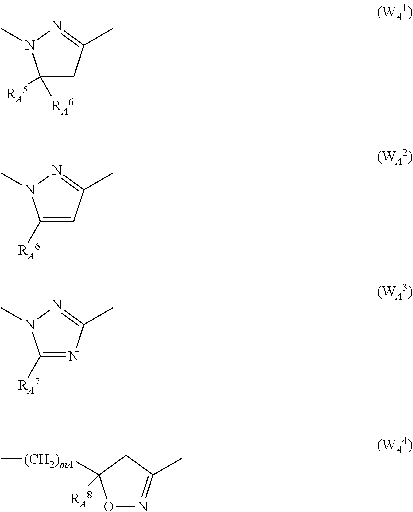

MA is 0 or 1;
R_{A}² is OR_{A}³, SR_{A}³ or NR_{A}³R_{A}⁴ or a saturated or unsaturated 3- to 7-membered heterocycle having at least one nitrogen atom and up to 3 heteroatoms, preferably from the group consisting of O and S, which is attached via the nitrogen atom to the carbonyl group in (S—I) and which is unsubstituted or substituted by radicals from the group consisting of (C₁-C₄)-alkyl, (C₁-C₄)-alkoxy and optionally substituted phenyl, preferably a radical of the formula OR_{A}³, NHR_{A}⁴ or N(CH₃)₂, in particular of the formula OR_{A}³;
R_{A}³ is hydrogen or an unsubstituted or substituted aliphatic hydrocarbon radical having preferably a total of 1 to 18 carbon atoms;
R_{A}⁴ is hydrogen, (C₁-C₆)-alkyl, (C₁-C₆)-alkoxy or substituted or unsubstituted phenyl;
R_{A}⁵ is H, (C₁-C₈)-alkyl, (C₁-C₈)-haloalkyl, (C₁-C₄)-alkoxy-(C₁-C₈)-alkyl, cyano or COOR_{A}⁹ where R_{A}⁹ is hydrogen, (C₁-C₈)-alkyl, (C₁-C₈)-haloalkyl, (C₁-C₄)-alkoxy-(C₁-C₄)-alkyl, (C₁-C₆)-hydroxyalkyl, (C₃-C₁₂)-cycloalkyl or tri-(C₁-C₄)-alkylsilyl;
R_{A}⁶, R_{A}⁷, R_{A}⁸ are identical or different and are hydrogen, (C₁-C₈)-alkyl, (C₁-C₈)-haloalkyl, (C₃-C₁₂)-cycloalkyl or substituted or unsubstituted phenyl;
   preferably:
   a) compounds of the type of the dichlorophenylpyrazoline-3-carboxylic acid, preferably compounds such as ethyl 1-(2,4-dichlorophenyl)-5-(ethoxycarbonyl)-5-methyl-2-pyrazoline-3-carboxylate (S1-1) (“mefenpyr-diethyl”, see Pestic. Man.), and related compounds, as described in WO 91/07874;
   b) derivatives of dichlorophenylpyrazolecarboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806;
   c) compounds of the type of the triazolecarboxylic acids, preferably compounds such as fenchlorazole(-ethyl), i.e. ethyl 1-(2,4-dichlorophenyl)-5-trichloro-methyl-(1H)-1,2,4-triazole-3-carboxylate (S1-6), and related compounds, as described in EP-A-174 562 and EP-A-346 620;
   d) compounds of the type of the 5-benzyl- or 5-phenyl-2-isoxazoline-3-carboxylic acid or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91/08202, or ethyl 5,5-diphenyl-2-isoxazolinecarboxylate (S1-9) (“isoxadifen-ethyl”) or n-propyl 5,5-diphenyl-2-isoxazolinecarboxylate (S1-10) or ethyl 5-(4-fluorophenyl)-5-phenyl-2-isoxazoline-3-carboxylate (S1-11), as described in the patent application WO-A-95/07897.

B) Quinoline derivatives of the formula (S-II)

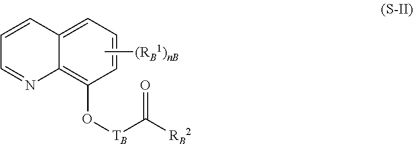

where the symbols and indices have the following meanings:
R_{B}¹ is halogen, (C₁-C₄)-alkyl, (C₁-C₄)-alkoxy, nitro or (C₁-C₄)-haloalkyl;
n_{B} is a natural number from 0 to 5, preferably from 0 to 3;
R_{B}² OR_{B}³, SR_{B}³ or NR_{B}³R_{B}⁴ or a saturated
or unsaturated 3- to 7-membered heterocycle having at least one nitrogen atom and up to 3 heteroatoms, preferably from the group consisting of O and S, which is attached via the nitrogen atom to the carbonyl group in (S-II) and is unsubstituted or substituted by radicals from the group consisting of (C₁-C₄)-alkyl, (C₁-C₄)-alkoxy or optionally substituted phenyl, preferably a radical of the formula OR_{B}³, NHR_{B}⁴ or N(CH₃)₂, in particular of the formula OR_{B}³;
R_{B}³ is hydrogen or an unsubstituted or substituted aliphatic hydrocarbon having preferably a total of 1 to 18 carbon atoms;
R_{B}⁴ is hydrogen, (C₁-C₆)-alkyl, (C₁-C₆)-alkoxy or substituted or unsubstituted phenyl;
T_{B} is a (C₁- or C₂)-alkanediyl chain which is unsubstituted or substituted by one or two (C₁-C₄)-alkyl radicals or by [(C₁-C₃)-alkoxy]carbonyl; preferably:
a) compounds of the type of the 8-quinolinoxyacetic acid (S2), preferably 1-methylhexyl (5-chloro-8-quinolinoxy)acetate (common name “cloquintocet-mexyl” (S2-1) (see Pestic. Man.), 1,3-dimethyl-but-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5), methyl (5-chloro-8-quinolinoxy)acetate (S2-6), allyl (5-chloro-8-quinolinoxy)acetate (S2-7), 2-(2-propylideneiminoxy)-1-ethyl (5-chloro-8-quinolinoxy)acetate (S2-8), 2-oxo-prop-1-yl (5-chloro-8-quinolinoxy)acetate (S2-9) and related compounds, as described in EP-A-86 750, EP-A-94 349 and EP-A-191 736 or EP-A-0 492 366, and also their hydrates and salts, as described in WO-A-2002/034048.
b) Compounds of the type of the (5-chloro-8-quinolinoxy)malonic acid, preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.

C) Compounds of the formula (S-III)

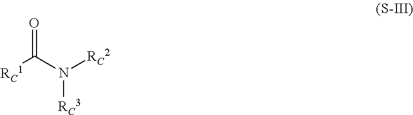

where the symbols and indices have the following meanings:
R_{c}¹ is (C₁-C₄)-alkyl, (C₁-C₄)-haloalkyl, (C₂-C₄)-alkenyl, (C₂-C₄)-haloalkenyl, (C₃-C₇)-cycloalkyl, preferably dichloromethyl;
R_{c}², R_{c}³ is are identical or different and are hydrogen, (C₁-C₄)-alkyl, (C₂-C₄)-alkenyl, (C₂-C₄)-alkynyl, (C₁-C₄)-haloalkyl, (C₂-C₄)-haloalkenyl, (C₁-C₄)-alkylcarbamoyl-(C₁-C₄)-alkyl, (C₂-C₄)-alkenylcarbamoyl-(C₁-C₄)-alkyl, (C₁-C₄)-alkoxy-(C₁-C₄)-alkyl, dioxolanyl-(C₁-C₄)-alkyl, thiazolyl, furyl, furylalkyl, thienyl, piperidyl, substituted or unsubstituted phenyl, or R_{c}² and R_{c}³ together form a substituted or unsubstituted heterocyclic ring,
preferably an oxazolidine, thiazolidine, piperidine, morpholine, hexahydropyrimidine or benzoxazine ring;
preferably:
active compounds of the type of the dichloroacetamides which are frequently used as pre-emergence safener (soil-acting safeners), such as, for example,
“dichlormid” (see Pestic. Man.) (=N,N-diallyl-2,2-dichloroacetamide),
“R-29148” (=3-dichloroacetyl-2,2,5-trimethyl-1,3-oxazolidine from Stauffer),
“R-28725” (=3-dichloroacetyl-2,2,-dimethyl-1,3-oxazolidine from Stauffer),
“benoxacor” (see Pestic. Man.) (=4-dichloroacetyl-3,4-dihydro-3-methyl-2H-1,4-benzoxazine),
“PPG-1292” (=N-allyl-N-[(1,3-dioxolan-2-yl)methyl]dichloroacetamide from PPG Industries),
“DKA-24” (=N-allyl-N-[(allylaminocarbonyl)methyl]dichloroacetamide from Sagro-Chem),
“AD-67” or “MON 4660” (=3-dichloroacetyl-1-oxa-3-aza-spiro[4,5]decane from Nitrokemia or Monsanto),
“TI-35” (=1-dichloroacetylazepane from TRI-Chemical RT)
“diclonon” (dicyclonone) or “BAS145138” or “LAB145138” (=3-dichloroacetyl-2,5,5-trimethyl-1,3-diazabicyclo[4.3.0]nonane from BASF) and
“furilazole” or “MON 13900” (see Pestic. Man.) (=(RS)-3-dichloroacetyl-5-(2-furyl)-2,2-dimethyloxazolidine).

D) N-Acylsulfonamides of the formula (S-IV) and their salts

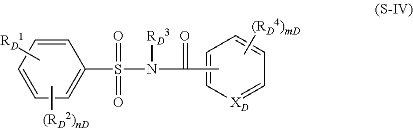

in which

### X_{D} is CH or N;

### R_{D}¹ is CO—NR_{D}⁵R_{D}⁶ or NHCO—R_{D}⁷;

R_{D}² is halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl or (C₁-C₄)-alkylcarbonyl;
R_{D}³ is hydrogen, (C₁-C₄)-alkyl, (C₂-C₄)-alkenyl or (C₂-C₄)-alkynyl;
R_{D}⁴ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl;
R_{D}⁵ is hydrogen, (C₁-C₆)-alkyl, (C₃-C₆)-cycloalkyl, (C₂-C₆)-alkenyl, (C₂-C₆)-alkynyl, (C₅-C₆)-cycloalkenyl, phenyl or 3- to 6-membered heterocyclyl containing v_{D} heteroatoms from the group consisting of nitrogen, oxygen and sulfur, where the seven last mentioned radicals are substituted by v_{D} substituents from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also (C₁-C₄)-alkyl and (C₁-C₄)-haloalkyl;
R_{D}⁶ is hydrogen, (C₁-C₆)-alkyl, (C₂-C₆)-alkenyl or (C₂-C₆)-alkynyl, where the three last mentioned radicals are substituted by v_{D} radicals from the group consisting of halogen, hydroxy, (C₁-C₄)-alkyl, (C₁-C₄)-alkoxy and (C₁-C₄)-alkylthio, or
R_{D}⁵ and R_{D}⁶ together with the nitrogen atom carrying them form a pyrrolidinyl or piperidinyl radical;
R_{D}⁷ is hydrogen, (C₁-C₄)-alkylamino, di-(C₁-C₄)-alkylamino, (C₁-C₆)-alkyl, (C₃-C₆)-cycloalkyl, where the 2 last mentioned radicals are substituted by v_{D} substituents from the group consisting of halogen, (C₁-C₄)-alkoxy, halogen-(C₁-C₆)-alkoxy and (C₁-C₄)-alkylthio and, in the case of cyclic radicals, also (C₁-C₄)-alkyl and (C₁-C₄)-haloalkyl;
nₚ is 0, 1 or 2;
m_{D} is 1 or 2;
v_{D} is 0, 1, 2 or 3;
from among these, preference is given to compounds of the type of the N-acylsulfonamides, for example of the formula (S-V) below, which are known, for example, from WO 97/45016

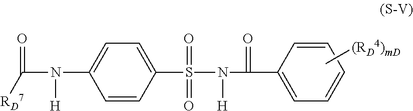

in which
R_{D}⁷ is (C₁-C₆)-alkyl, (C₃-C₆)-cycloalkyl, where the 2 last mentioned radicals are substituted by v_{D} substituents from the group consisting of halogen, (C₁-C₄)-alkoxy, halogen-(C₁-C₆)-alkoxy and (C₁-C₄)-alkylthio and, in the case of cyclic radicals, also (C₁-C₄)-alkyl and (C₁-C₄)-haloalkyl;
R_{D}⁴ is halogen, (C₁-C₄)-alkyl, (C₁-C₄)-alkoxy, CF₃,
m_{D} is 1 or 2;
v_{D} is 0, 1, 2 or 3;
and also
acylsulfamoylbenzamides, for example of the formula (S-VI) below, which are known, for example, from WO 99/16744,

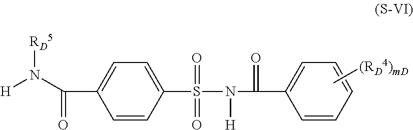

for example those in which
R_{D}⁵=cyclopropyl and (R_{D}⁴)=2-OMe (“cyprosulfamide”, S3-1),
R_{D}⁵=cyclopropyl and (R_{D}⁴)=5-Cl-2-OMe (S3-2),
R_{D}⁵=ethyl and (R_{D}⁴)=2-OMe (S3-3),
R_{D}⁵=isopropyl and (R_{D}⁴)=5-Cl-2-OMe (S3-4) and
R_{D}⁵=isopropyl and (R_{D}⁴)=2-OMe (S3-5);
and also
compounds of the type of the N-acylsulfamoylphenylureas of the formula (S-VII), which are known, for example, from EP-A-365484

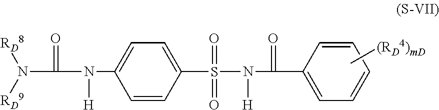

in which
R_{D}⁸ and R_{D}⁹ independently of one another are hydrogen, (C₁-C₈)-alkyl, (C₃-C₈)-cycloalkyl, (C₃-C₆)-alkenyl, (C₃-C₆)-alkynyl,
R_{D}⁴ is halogen, (C₁-C₄)-alkyl, (C₁-C₄)-alkoxy, CF₃
m_{D} is 1 or 2;
from among these in particular
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea,
1-[4-(N-naphthoylsulfamoyl)phenyl]-3,3-dimethylurea,

G) active compounds from the class of the hydroxyaromatics and aromatic-aliphatic carboxylic acid derivatives, for example

ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 1,2-dihydro-2-oxo-6-trifluoromethylpyridine-3-carboxamide, 2-hydroxycinnamic acid, 2,4-dichlorocinnamic acid, as described in WO 2004084631, WO 2005015994, WO 2006007981, WO 2005016001;

H) active compounds from the class of the 1,2-dihydroquinoxalin-2-ones, for example

1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydro-quinoxalin-2-one, as described in WO 2005112630,

I) active compounds which, in addition to a herbicidal action against harmful plants, also have safener action on crop plants such as rice, such as, for example,

“dimepiperate” or “MY-93” (see Pestic. Man.) (═S-1-methyl-1-phenylethyl piperidine-1-thiocarboxylate), which is known as safener for rice against damage by the herbicide molinate,
“daimuron” or “SK 23” (see Pestic. Man.) (=1-(1-methyl-1-phenylethyl)-3-p-tolyl-urea), which is known as safener for rice against damage by the herbicide imazosulfuron,
“cumyluron”=“JC-940” (=3-(2-chlorophenylmethyl)-1-(1-methyl-1-phenyl-ethyl)urea, see JP-A-60087254), which is known as safener for rice against damage by a number of herbicides,
“methoxyphenone” or “NK 049” (=3,3′-dimethyl-4-methoxybenzophenone), which is known as safener for rice against damage by a number of herbicides,
“CSB” (=1-bromo-4-(chloromethylsulfonyl)benzene) (CAS Reg. No. 54091-06-4 from Kumiai), which is known as safener against damage by a number of herbicides in rice,

K) compounds of the formula (S-IX),
as described in WO-A-1998/38856

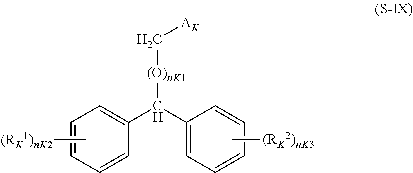

in which the symbols and indices have the following meanings:
R_{K}¹, R_{K}² independently of one another are halogen, (C₁-C₄)-alkyl, (C₁-C₄)-alkoxy, (C₁-C₄)-haloalkyl, (C₁-C₄)-alkylamino, di-(C₁-C₄)-alkylamino, nitro;

### A_{K} is COOR_{K}³ or COOR_{K}⁴

R_{K}³, R_{K}⁴ independently of one another are hydrogen, (C₁-C₄)-alkyl, (C₂-C₆)-alkenyl, (C₂-C₄)-alkynyl, cyanoalkyl, (C₁-C₄)-haloalkyl, phenyl, nitrophenyl, benzyl, halobenzyl, pyridinylalkyl or alkylammonium,
n_{K}¹ is 0 or 1,
n_{K}², n_{K}³ independently of one another are 0, 1 or 2
preferably: methyl (diphenylmethoxy)acetate (CAS Reg. No.: 41858-19-9),

L) compounds of the formula (S-X),
as described in WO A-98/27049

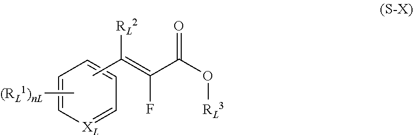

in which the symbols and indices have the following meanings:

### X_{L} is CH or N,

n_{L} is, in the case that X═N, an integer from 0 to 4 and,
in the case that X═CH, an integer from 0 to 5,
   R_{L}¹ is halogen, (C₁-C₄)-alkyl, (C₁-C₄)-haloalkyl, (C₁-C₄)-alkoxy, (C₁-C₄)-haloalkoxy, nitro, (C₁-C₄)-alkylthio, (C₁-C₄)-alkylsulfonyl, (C₁-C₄)-alkoxycarbonyl, optionally substituted phenyl, optionally substituted phenoxy,
   R_{L}² is hydrogen or (C₁-C₄)-alkyl,
   R_{L}³ is hydrogen, (C₁-C₈)-alkyl, (C₂-C₄)-alkenyl, (C₂-C₄)-alkynyl or aryl, where each of the carbon-containing radicals mentioned above is unsubstituted or substituted by one or more, preferably by up to three, identical or different radicals from the group consisting of halogen and alkoxy; or salts thereof.

M) Active compounds from the class of the 3-(5-tetrazolylcarbonyl)-2-quinolones, for example

1,2-dihydro-4-hydroxy-1-ethyl-345-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No.: 95855-00-8), as described in WO-A-1999000020,

N) compounds of the formulae (S-XI) or (S-XII),
as described in WO-A-2007023719 and WO-A-2007023764

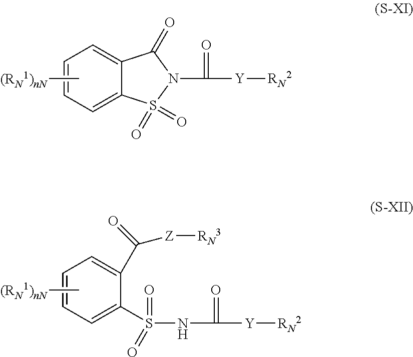

in which
R_{N}¹ is halogen, (C₁-C₄)-alkyl, methoxy, nitro, cyano, CF₃, OCF₃
Y, Z independently of one another are O or S,
n_{N} is an integer from 0 to 4,
R_{N}² is (C₁-C₁₆)-alkyl, (C₂-C₆)-alkenyl, (C₃-C₆)-cycloalkyl, aryl, benzyl, halobenzyl,
R_{N}³ is hydrogen, (C₁-C₆)alkyl;

O) one or more compounds from the group consisting of:
1,8-naphthalic anhydride,
O,O-diethyl S-2-ethylthioethyl phosphorodithioate (disulfoton),
4-chlorophenyl methylcarbamate (mephenate),
O,O-diethyl O-phenyl phosphorothioate (dietholate),
4-carboxy-3,4-dihydro-2H-1-benzopyran-4-acetic acid (CL-304415, CAS Reg. No.: 31541-57-8),
2-propenyl 1-oxa-4-azaspiro[4.5]decane-4-carbodithioate (MG-838, CAS Reg. No.: 133993-74-5),
methyl [(3-oxo-1H-2-benzothiopyran-4(3H)-ylidene)methoxy]acetate (from WO-A-98/13361; CAS Reg. No.: 205121-04-6),
cyanomethoxyimino(phenyl)acetonitrile (cyometrinil),
1,3-dioxolan-2-ylmethoxyimino(phenyl)acetonitrile (oxabetrinil),
4′-chloro-2,2,2-trifluoroacetophenone O-1,3-dioxolan-2-ylmethyloxime (fluxofenim),
4,6-dichloro-2-phenylpyrimidine (fenclorim),
benzyl 2-chloro-4-trifluoromethyl-1,3-thiazole-5-carboxylate (flurazole),
2-dichlormethyl-2-methyl-1,3-dioxolane (MG-191),
   including the stereoisomers, and the salts customary in agriculture.

A mixture with other known active compounds, such as fungicides, insecticides, acaricides, nematicides, bird repellents, plant nutrients and soil structure improvers is likewise possible.

Some of the safeners are already known as herbicides and accordingly, in addition to the herbicidal action against harmful plants, also act by protecting the crop plants. The weight ratios of herbicide (mixture) to safener generally depend on the herbicide application rate and the effectiveness of the safener in question and may vary within wide limits, for example in the range from 20 000:1 to 1:20 000, preferably from 15 000:1 to 1:15 000, in particular from 10 000:1 to 1:10 000. The safeners may be formulated analogously to the compounds of the formula (I) or their mixtures with other herbicides/pesticides and be provided and used as a finished formulation or as a tank mix with the herbicides. The combinations according to the invention (=herbicidal compositions) have excellent herbicidal activity against a broad spectrum of economically important monocotyledonous and dicotyledonous harmful plants, such as weeds, including species which are resistant to herbicidally active compounds such as glyphosate, glufosinate, atrazine or imidazolinone herbicides. The active compounds also act efficiently on perennial weeds which produce shoots from rhizomes, root stocks and other perennial organs and which are difficult to control. Here, the substances can be applied, for example, by the pre-sowing method, the pre-emergence method or the post-emergence method, for example jointly or separately. Preference is given, for example, to application by the post-emergence method, in particular to the emerged harmful plants.

Specific examples may be mentioned of some representatives of the monocotyledonous and dicotyledonous weed flora which can be controlled by the compounds according to the invention, without the enumeration being restricted to certain species.

Examples of weed species on which the herbicidal compositions act efficiently are, from amongst the monocotyledonous weed species, Avena spp., Alopecurus spp., Apera spp., Brachiaria spp., Bromus spp., Digitaria spp., Lolium spp., Echinochloa spp., Panicum spp., Phalaris spp., Poa spp., Setaria spp. and also Cyperus species from the annual group, and, among the perennial species, Agropyron, Cynodon, Imperata and Sorghum and also perennial Cyperus species.

In the case of the dicotyledonous weed species, the spectrum of action extends to genera such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., among the annuals, and Convolvulus, Cirsium, Rumex and Artemisia in the case of the perennial weeds.

If the compounds according to the invention are applied to the soil surface before germination, the weed seedlings are either prevented completely from emerging or else the weeds grow until they have reached the cotyledon stage, but then their growth stops, and, eventually, after three to four weeks have elapsed, they die completely.

If the active compounds are applied post-emergence to the green parts of the plants, growth likewise stops drastically a very short time after the treatment, and the weed plants remain at the growth stage of the point of time of application, or they die completely after a certain time, so that in this manner competition by the weeds, which is harmful to the crop plants, is eliminated very early and in a sustained manner.

The herbicidal compositions according to the invention are distinguished by a rapidly commencing and long-lasting herbicidal action. As a rule, the rainfastness of the active compounds in the combinations according to the invention is favorable. A particular advantage is that the dosages used in the combinations and the effective dosages of compounds (A) and (B) can be adjusted to such a low level that their soil action is optimally low. This does not only allow them to be employed in sensitive crops in the first place, but ground water contaminations are virtually avoided. The combinations according to the invention of active compounds allow the required application rate of the active compounds to be reduced considerably.

When herbicides of group (A) and those of group (B) are applied jointly, there are preferably superadditive (=synergistic) effects. Here, the activity in the combinations is higher than the expected sum of the activities of the individual herbicides employed. The synergistic effects allow the application rate to be reduced, a broader spectrum of broad-leaved weeds and weed grasses to be controlled, a more rapid onset of the herbicidal action, a longer persistency, a better control of the harmful plants with only one or a few applications and a widening of the application period possible. To some extent, by using the compositions, the amount of harmful ingredients, such as nitrogen or oleic acid, and their introduction into the soil are likewise reduced.

The abovementioned properties and advantages are necessary for weed control practice to keep agricultural crops and forestry crops free of unwanted competing plants, and thus to ensure and/or increase yield levels from the qualitative and quantitative angle. These novel combinations markedly exceed the technical state of the art with a view to the properties described.

Owing to their herbicidal and plant growth-regulatory properties, the compositions can be employed for controlling harmful plants in known plant crops or in tolerant or genetically modified crop plants still to be developed. In general, the transgenic plants are distinguished by specific advantageous properties, in addition to resistances to the compositions according to the invention, for example, by resistances to plant diseases or the causative organisms of plant diseases such as certain insects or microorganisms, such as fungi, bacteria or viruses. Other specific characteristics relate, for example, to the harvested material with regard to quantity, quality, storability, composition and specific constituents. Thus, transgenic plants are known whose starch content is increased, or whose starch quality is altered, or those where the harvested material has a different fatty acid composition. In the same manner, owing to their herbicidal and plant growth-regulatory properties, the active compounds can also be used for controlling harmful plants in crops of known plants or plants still to be developed by mutant selection.

Conventional methods of generating novel plants which have modified properties in comparison to plants occurring to date consist, for example, in traditional breeding methods and the generation of mutants. Alternatively, novel plants with altered properties can be generated with the aid of recombinant methods (see, for example, EP-A-0221044, EP-A-0131624). For example, the following have been described in several cases:
the modification, by recombinant technology, of crop plants with the aim of modifying the starch synthesized in the plants (for example WO 92/11376, WO 92/14827, WO 91/19806),
transgenic crop plants which exhibit resistances to herbicides, for example to sulfonylureas (EP-A-0257993, U.S. Pat. No. 5,013,659),
transgenic crop plants with the capability of producing Bacillus thuringiensis toxins (Bt toxins), which make the plants resistant to certain pests (EP-A-0142924, EP-A-0193259),
transgenic crop plants with a modified fatty acid composition (WO 91/13972).

A large number of techniques in molecular biology are known in principle with the aid of which novel transgenic plants with modified properties can be generated; see, for example, Sambrook et al., 1989, Molecular Cloning, A Laboratory Manual, 2^{nd} Edition, Cold Spring Harbor Laboratory Press, Cold Spring Harbor, N.Y.; or Winnacker “Gene and Klone”, VCH Weinheim 2^{nd} Edition 1996 or Christou, “Trends in Plant Science” 1 (1996) 423-431).

To carry out such recombinant manipulations, nucleic acid molecules which allow mutagenesis or sequence changes by recombination of DNA sequences can be introduced into plasmids. For example, the abovementioned standard methods allow base exchanges to be carried out, subsequences to be removed, or natural or synthetic sequences to be added. To connect the DNA fragments to each other, adapters or linkers may be added to the fragments.

For example, the generation of plant cells with a reduced activity of a gene product can be achieved by expressing at least one corresponding antisense RNA, a sense RNA for achieving a cosuppression effect or by expressing at least one suitably constructed ribozyme which specifically cleaves transcripts of the abovementioned gene product.

To this end, it is possible to use DNA molecules which encompass the entire coding sequence of a gene product inclusive of any flanking sequences which may be present, and also DNA molecules which only encompass portions of the coding sequence, it being necessary for these portions to be long enough to have an antisense effect in the cells. The use of DNA sequences which have a high degree of homology to the coding sequences of a gene product, but are not completely identical to them, is also possible.

When expressing nucleic acid molecules in plants, the protein synthesized can be localized in any desired compartment of the plant cell. However, to achieve localization in a particular compartment, it is possible, for example, to link the coding region with DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated by known techniques to give rise to entire plants. In principle, the transgenic plants can be plants of any desired plant species, i.e. not only monocotyledonous, but also dicotyledonous, plants. Thus, transgenic plants can be obtained whose properties are altered by overexpression, suppression or inhibition of homologous (=natural) genes or gene sequences or the expression of heterologous (=foreign) genes or gene sequences.

The present invention furthermore provides a method for controlling unwanted plants, preferably in crop plants, which comprises applying the herbicides (A) and (B) of the herbicide combination according to the invention to the plants (for example harmful plants, such as monocotyledonous or dicotyledonous weeds or unwanted crop plants), the seed (for example grains, seeds or vegetative propagation organs, such as tubers or shoot parts with buds) or to the area in which the plants grow (for example the area under cultivation), for example together or separately. One or more herbicides (A) may be applied before, after or simultaneously with the herbicide(s) (B) to the plants, the seed or the area in which the plants grow (for example the area under cultivation).

Unwanted plants are to be understood as meaning all plants which grow in locations where they are unwanted. This can, for example, be harmful plants (for example monocotyledonous or dicotyledonous weeds or unwanted crop plants), including, for example, those which are resistant to certain herbicidally active compounds, such as glyphosate, atrazine, glufosinate or imidazolinone herbicides.

The herbicidal combinations according to the invention are employed selectively for controlling unwanted vegetation, for example in crop plants such as farm crops, for example monocotyledonous farm crops, such as cereals (for example wheat, barley, rye, oats), rice, corn, millet, or dicotyledonous farm crops, such as sugar beet, oilseed rape, cotton, sunflowers and leguminous plants, for example of the genera Glycine (for example Glycine max. (soybean), such as non-transgenic Glycine max. (for example conventional cultivars, such as STS cultivars) or transgenic Glycine max. (for example RR-soybean or LL-soybean) and crossbreeds thereof), Phaseolus, Pisum, Vicia and Arachis, or vegetable crops from various botanical groups, such as potato, leek, cabbage, carrot, tomato, onion. The application is preferably carried out to the emerged harmful plants (for example weeds or unwanted crop plants), in particular prior to the emergence of (wanted) crop plants.

The invention also provides the use of the herbicide combinations according to the invention for controlling unwanted vegetation, preferably in crop plants.

The herbicide combinations according to the invention can be prepared by known processes, for example as mixed formulations of the individual components, if appropriate with further active compounds, additives and/or customary formulation auxiliaries, which combinations are then applied in a customary manner diluted with water, or as tank mixes by joint dilution of the components, formulated separately or formulated partially separately, with water. Also possible is the split application of the separately formulated or partially separately formulated individual components. It is also possible to apply the herbicides or the herbicide combinations in a plurality of portions (sequential application) using, for example, pre-emergence applications followed by post-emergence applications or using early post-emergence applications followed by medium or late post-emergence applications. Preference is given here to the joint or almost simultaneous application of the active compounds of the combination in question.

The herbicides (A) and (B) can be converted jointly or separately into customary formulations, such as solutions, emulsions suspensions, powders, foams, pastes, granules, aerosols, natural and synthetic materials impregnated with active compound and microencapsulations in polymeric materials. The formulations may comprise the customary auxiliaries and additives.

These formulations are produced in a known manner, for example by mixing the active compounds with extenders, that is liquid solvents, pressurized liquefied gases and/or solid carriers, if appropriate with the use of surfactants, that is emulsifiers and/or dispersants, and/or foam formers.

If the extender used is water, it is also possible to use, for example, organic solvents as auxiliary solvents. Suitable liquid solvents are essentially: aromatics, such as xylene, toluene, alkylnaphthalenes, chlorinated aromatics or chlorinated aliphatic hydrocarbons, such as chlorobenzenes, chloroethylenes, or methylene chloride, aliphatic hydrocarbons, such as cyclohexane or paraffins, for example mineral oil fractions, mineral and vegetable oils, alcohols, such as butanol or glycol, and ethers and esters thereof, ketones, such as acetone, methyl ethyl ketone, methyl isobutyl ketone or cyclohexanone, strongly polar solvents, such as dimethylformamide or dimethyl sulfoxide, and also water.

Suitable solid carriers are: for example ammonium salts and ground natural minerals, such as kaolins, clays, talc, chalk, quartz, attapulgite, montmorillonite or diatomaceous earth, and ground synthetic minerals, such as finely divided silica, alumina and silicates; suitable solid carriers for granules are: for example crushed and fractionated natural rocks, such as calcite, marble, pumice, sepiolite and dolomite, and also synthetic granules of inorganic and organic meals, and granules of organic material, such as sawdust, coconut shells, corn cobs and tobacco stalks; suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates and also protein hydrolysates; suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, and also natural phospholipids, such as cephalins and lecithins and synthetic phospholipids, can be used in the formulations. Other possible additives are mineral and vegetable oils.

The herbicidal action of the herbicide combinations according to the invention can be improved, for example, by surfactants, preferably by wetting agents from the group of the fatty alcohol polyglycol ethers. The fatty alcohol polyglycol ethers preferably comprise 10-18 carbon atoms in the fatty alcohol radical and 2-20 ethylene oxide units in the polyglycol ether moiety. The fatty alcohol polyglycol ethers may be present in nonionic form, or ionic form, for example in the form of fatty alcohol polyglycol ether sulfates, which may be used, for example, as alkali metal salts (for example sodium salts and potassium salts) or ammonium salts, or even as alkaline earth metal salts, such as magnesium salts, such as C₁₂/C₁₄-fatty alcohol diglycol ether sulfate sodium (Genapol® LRO, Clariant GmbH); see, for example, EP-A-0476555, EP-A-0048436, EP-A-0336151 or U.S. Pat. No. 4,400,196 and also Proc. EWRS Symp. “Factors Affecting Herbicidal Activity and Selectivity”, 227-232 (1988). Nonionic fatty alcohol polyglycol ethers are, for example, (C₁₀-C₁₈)—, preferably (C₁₀-C₁₄)-fatty alcohol polyglycol ethers (for example isotridecyl alcohol polyglycol ethers) which comprise, for example, 2-20, preferably 3-15, ethylene oxide units, for example those from the Genapol® X-series, such as Genapol® X-030, Genapol® X-060, Genapol® X-080 or Genapol® X-150 (all from Clariant GmbH).

The present invention further comprises the combination of components A and B with the wetting agents mentioned above from the group of the fatty alcohol polyglycol ethers which preferably contain 10-18 carbon atoms in the fatty alcohol radical and 2-20 ethylene oxide units in the polyglycol ether moiety and which may be present in nonionic or ionic form (for example as fatty alcohol polyglycol ether sulfates). Preference is given to C₁₂/C₁₄-fatty alcohol diglycol ether sulfate sodium (Genapol® LRO, Clariant GmbH) and isotridecyl alcohol polyglycol ether having 3-15 ethylene oxide units, for example from the Genapol® X-series, such as Genapol®X-030, Genapol® X-060, Genapol® X-080 and Genapol® X-150 (all from Clariant GmbH). Furthermore, it is known that fatty alcohol polyglycol ethers, such as nonionic or ionic fatty alcohol polyglycol ethers (for example fatty alcohol polyglycol ether sulfates) are also suitable for use as penetrants and activity enhancers for a number of other herbicides (see, for example, EP-A-0502014).

Furthermore, it is known that fatty alcohol polyglycol ethers, such as nonionic or ionic fatty alcohol polyglycol ethers (for example fatty alcohol polyglycol ether sulfates) are also suitable for use as penetrants and activity enhancers for a number of other herbicides (see, for example, EP-A-0502014).

The herbicidal action of the herbicide combinations according to the invention can also be enhanced by using vegetable oils. The term vegetable oils is to be understood as meaning oils of oleaginous plant species, such as soybean oil, rapeseed oil, corn oil, sunflower oil, cottonseed oil, linseed oil, coconut oil, palm oil, thistle oil or castor oil, in particular rapeseed oil, and also their transesterification products, for example alkyl esters, such as rapeseed oil methyl ester or rapeseed oil ethyl ester.

The vegetable oils are preferably esters of C₁₀-C₂₂-, preferably C₁₂-C₂₀-, fatty acids. The C₁₀-C₂₂-fatty acid esters are, for example, esters of unsaturated or saturated C₁₀-C₂₂-fatty acids, in particular those having an even number of carbon atoms, for example erucic acid, lauric acid, palmitic acid and in particular C₁₈-fatty acids, such as stearic acid, oleic acid, linoleic acid or linolenic acid.

Examples of C₁₀-C₂₂-fatty acid esters are esters obtained by reacting glycerol or glycol with the C₁₀-C₂₂-fatty acids contained, for example, in oils of oleaginous plant species, or C₁-C₂₀-alkyl-C₁₀-C₂₂-fatty acid esters which can be obtained, for example, by transesterification of the aforementioned glycerol- or glycol-C₁₀-C₂₂-fatty acid esters with C₁-C₂₀-alcohols (for example methanol, ethanol, propanol or butanol). The transesterification can be carried out by known methods as described, for example, in Römpp Chemie Lexikon, 9th edition, Volume 2, page 1343, Thieme Verlag Stuttgart.

Preferred C₁-C₂₀-alkyl-C₁₀-C₂₂-fatty acid esters are methyl esters, ethyl esters, propyl esters, butyl esters, 2-ethylhexyl esters and dodecyl esters. Preferred glycol- and glycerol-C₁₀-C₂₂-fatty acid esters are the uniform or mixed glycol esters and glycerol esters of C₁₀-C₂₂-fatty acids, in particular fatty acids having an even number of carbon atoms, for example erucic acid, lauric acid, palmitic acid and, in particular, C₁₈-fatty acids, such as stearic acid, oleic acid, linoleic acid or linolenic acid.

In the herbicidal compositions according to the invention, the vegetable oils can be present, for example, in the form of commercially available oil-containing formulation additives, in particular those based on rapeseed oil, such as Hasten® (Victorian Chemical Company, Australia, hereinbelow referred to as Hasten, main ingredient: rapeseed oil ethyl ester), Actirob®B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

In a further embodiment, the present invention comprises combinations with the vegetable oils mentioned above, such as rapeseed oil, preferably in the form of commercially available oil-containing formulation additives, in particular those based on rapeseed oil, such as Hasten® (Victorian Chemical Company, Australia, hereinbelow referred to as Hasten, main ingredient: rapeseed oil ethyl ester), Actirob®B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

It is possible to use colorants, such as inorganic pigments, for example iron oxide, titanium oxide, Prussian Blue, and organic dyes, such as alizarin dyes, azo dyes and metal phthalocyanine dyes, and trace nutrients such as salts of iron, manganese, boron, copper, cobalt, molybdenum and zinc.

The formulations generally comprise from 0.1 to 95% by weight of active compound, preferably from 0.5 to 90% by weight.

As such or in their formulations, the herbicides (A) and (B) can also be used as a mixture with other agrochemically active compounds, such as known herbicides, for controlling unwanted vegetation, for example for controlling weeds or for controlling unwanted crop plants, finished formulations or tank mixes, for example, being possible.

A mixture with other known active compounds, such as fungicides, insecticides, acaricides, nematicides, safeners, bird repellants, plant nutrients and soil structure improvers is likewise possible.

The herbicides (A) and (B) can be used as such, in the form of their formulations or in the use forms prepared therefrom by further dilution, such as ready-to-use solutions, suspensions, emulsions, powders, pastes and granules. Application is carried out in a customary manner, for example by watering, spraying, atomizing, broadcasting.

The active compounds can be applied to the plants (for example harmful plants, such as monocotyledonous or dicotyledonous weeds or unwanted crop plants), the seed (for example grains, seeds or vegetative propagation organs, such as tubers or shoot parts with buds) or the area under cultivation (for example the soil), preferably to the green plants and parts of plants and, if appropriate, additionally the soil. One possible use is the joint application of the active compounds in the form of tank mixes, where the optimally formulated concentrated formulations of the individual active compounds are, together, mixed in a tank with water, and the spray liquor obtained is applied.

A joint herbicidal formulation of the combination according to the invention of herbicides (A) and (B) has the advantage that it is easier to apply, since the amounts of the components are already in an optimum ratio. Moreover, the auxiliaries in the formulation can be adjusted optimally to one another.

### BIOLOGICAL EXAMPLES

### 1. Pre-Emergence Action Against Weeds

Seeds or rhizome pieces of monocotyledonous and dicotyledonous weed plants were placed in sandy loam soil in cardboard pots and covered with soil. The active compounds (A) and (B), formulated as wettable powders or emulsion concentrates, were then applied to the surface of the covering soil as aqueous suspensions or emulsions in different dosages at a water application rate of 100 to 800 l/ha (converted).

After the treatment, the pots were placed in a greenhouse and kept under good growth conditions for the weeds. Visual scoring of the plant damage or emergence damage was carried out after the test plants had emerged after a test period of 3 to 4 weeks, in comparison to untreated controls. The results show that the tested herbicide combinations have good herbicidal pre-emergence activity against a broad spectrum of weed grasses and broad-leaved weeds. The herbicide combinations of 2-iodo-N-[(4-methoxy-6-methyl-1,3,5-triazin-2-yl)carbamoyl]benzenesulfonamide and compounds of the formula (I) mentioned in table A with compounds of group B have very good synergistic herbicidal activity against harmful plants such as Sinapis alba, Chrysanthemum segetum, Avena sativa, Stellaria media, Echinochloa crus-galli, Lolium multiflorum, Setaria viridis, Abutilon theophrasti, Amaranthus retroflexus and Panicum miliaceum when applied by the pre-emergence method at an application rate of 100 g or less of active substance per hectare.

### 2. Post-Emergence Action Against Weeds

Seeds or rhizome pieces of monocotyledonous and dicotyledonous weeds were placed in sandy loam soil in plastic pots, covered with soil and cultivated in a greenhouse under good growth conditions. Three weeks after sowing, the test plants were treated at the 2- to 4-leaf stage. The compounds according to the invention, formulated as wettable powders or as emulsion concentrates, were sprayed onto the green parts of the plants in various dosages at a water application rate of 100 to 800 l/ha (converted). After the test plants had been left to stand in the greenhouse for 10 to 28 days under optimum growth conditions, the effect of the preparations was scored visually in comparison to untreated controls.

In general, the herbicide combinations according to the invention also have good herbicidal post-emergence activity against a broad spectrum of economically important weed grasses and broad-leaved weeds. The herbicide combinations of 2-iodo-N-[(4-methoxy-6-methyl-1,3,5-triazin-2-yl)carbamoyl]benzenesulfonamide and compounds of the formula (I) mentioned in table A with compounds of group B have very good synergistic herbicidal activity against harmful plants such as Sinapis alba, Echinochloa crus-galli, Digitaria sanguinalis, Lolium multiflorum, Chrysanthemum segetum, Setaria viridis, Polygonum convolvulus, Abutilon theophrasti, Amaranthus retroflexus, Panicum miliaceum and Avena sativa when applied by the post-emergence method at an application rate of 100 g or less of active substance per hectare.

In an exemplary manner, table 1 below shows the improved control of the weed Polygonum convolvulus by application of the herbicide combinations according to the invention using the combination of the compound A-2 (sodium salt of 2-iodo-N-[(4-methoxy-6-methyl-1,3,5-triazin-2-yl)carbamoyl]benzenesulfonamide)+dicamba (=B1-1), the evaluation being carried out 11 days after application and the control of the weed being scored according to the scheme below:

0%=no control
100%=complete control

TABLE 1

| | Amount of active | |
|---|---|---|
| Active | compound | Polygonum convolvulus |
| compound | g of ai/ha | Control in % |
| A-2 | 2.5 | 10 |
| B1-1 | 100 | 40 |
| A-2 + B1-1 | 2.5 + 100 | 83 |

In an exemplary manner, table 2 below shows the improved control of the weed Polygonum convolvulus by application of the herbicide combinations according to the invention using the combination of the compound A-2 (sodium salt of 2-iodo-N-[(4-methoxy-6-methyl-1,3,5-triazin-2-yl)carbamoyl]benzenesulfonamide)+aminocyclopyrachlor (=B6-1), the evaluation being carried out 11 days after application and the control of the weed being scored according to the scheme below:

0%=no control
100%=complete control

TABLE 2

| | Amount of active | |
|---|---|---|
| Active | compound | Polygonum convolvulus |
| compound | g of ai/ha | Control in % |
| A-2 | 2.5 | 0 |
| B6-1 | 25 | 60 |
| A-2 + B6-1 | 2.5 + 25 | 75 |

In an exemplary manner, table 3 below shows the improved control of the weed Veronica persica by application of the herbicide combinations according to the invention using the combination of the compound A-2 (sodium salt of 2-iodo-N-[(4-methoxy-6-methyl-1,3,5-triazin-2-yl)carbamoyl]benzenesulfonamide)+fluoroxypyr (=B2-2), the evaluation being carried out 11 days after application and the control of the weed being scored according to the scheme below:

0%=no control
100%=complete control

TABLE 3

| | Amount of active | |
|---|---|---|
| Active | compound | Veronica persica |
| compound | g of ai/ha | Control in % |
| A-2 | 2.5 | 0 |
| B2-2 | 80 | 60 |
| A-2 + B2-2 | 2.5 + 80 | 65 |

In an exemplary manner, table 4 below shows the improved control of the weed Veronica persica by application of the herbicide combinations according to the invention using the combination of the compound A-2 (sodium salt of 2-iodo-N-[(4-methoxy-6-methyl-1,3,5-triazin-2-yl)carbamoyl]benzenesulfonamide)+clopyralid (=B2-1), the evaluation being carried out 11 days after application and the control of the weed being scored according to the scheme below:

0%=no control
100%=complete control

TABLE 4

| | Amount of active | |
|---|---|---|
| Active | compound | Veronica persica |
| compound | g of ai/ha | Control in % |
| A-2 | 2.5 | 0 |
| B2-1 | 50 | 0 |
| A-2 + B2-1 | 2.5 + 50 | 30 |

In an exemplary manner, table 5 below shows the improved control of the weed Polygonum convolvulus by application of the herbicide combinations according to the invention using the combination of the compound A-2 (sodium salt of 2-iodo-N-[(4-methoxy-6-methyl-1,3,5-triazin-2-yl)carbamoyl]benzenesulfonamide)+picloram (=B2-4), the evaluation being carried out 11 days after application and the control of the weed being scored according to the scheme below:

0%=no control
100%=complete control

TABLE 5

| | Amount of active | |
|---|---|---|
| Active | compound | Polygonum convolvulus |
| compound | g of ai/ha | Control in % |
| A-2 | 2.5 | 20 |
| B2-4 | 80 | 20 |
| A-2 + B2-4 | 2.5 + 80 | 45 |

1. An herbicide combination comprising components (A) and (B), where
(A) is at least one herbicide selected from the group consisting of 2-iodo-N-[(4-methoxy-6-methyl-1,3,5-triazin-2-yl)carbamoyl]benzenesulfonamide and compounds of formula (I) 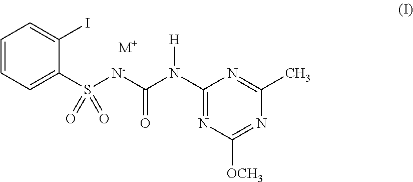
where
the cation (M⁺) is
(a) an alkali metal ion, or
(b) an alkaline earth metal ion, or
(c) a transition metal ion, or
(d) an ammonium ion where optionally one, two or three or all four hydrogen atoms are substituted by identical or different radicals from the group consisting of (C₁-C₄)-alkyl, hydroxy-(C₁-C₄)-alkyl, (C₃-C₆)-cycloalkyl, (C₁-C₄)-alkoxy-(C₁-C₄)-alkyl, hydroxy-(C₁-C₄)-alkoxy-(C₁-C₄)-alkyl, (C₁-C₆)-mercaptoalkyl, phenyl and benzyl,
where the radicals mentioned above are optionally substituted by one or more identical or different radicals from the group consisting of halogen, nitro, cyano, azido, (C₁-C₆)-alkyl, (C₁-C₆)-haloalkyl, (C₃-C₆)-cycloalkyl, (C₁-C₆)-alkoxy, (C₁-C₆)-haloalkoxy and phenyl and where in each case two substituents at the nitrogen atom together optionally form an unsubstituted or substituted ring, or
(e) a phosphonium ion, or
(f) a sulfonium ion, or
(g) an oxonium ion, or
(h) a saturated or unsaturated/aromatic nitrogenous heterocyclic ionic compound which has 1-10 carbon atoms in the ring system and is optionally mono- or polycondensed and/or substituted by (C₁-C₄)-alkyl,
and
(B) is at least one herbicide selected from the group consisting of the (het)arylcarboxyl acids comprising:
dicamba; 2,3,6-TBA; clopyralid; fluoroxypyr; inabenfide; picloram; triclopyr; quinclorac; quinmerac; indol-3-ylacetic acid; 4-indol-3-ylbutyric acid; 2-(1-naphthyl)acetamide; 1-naphthylacetic acid; 2-naphthyloxyacetic acid; and aminocyclopyrachlor.

2. The herbicide combination as claimed in claim 1 wherein component (A) is
2-iodo-N-[(4-methoxy-6-methyl-1,3,5-triazin-2-yl)carbamoyl]benzenesulfonamide and/or a compound of formula (I)
in which the cation (M⁺) is
(a) an alkali metal ion, or
(b) an alkaline earth metal ion, or
(c) a transition metal ion, or
(d) an ammonium ion where optionally one, two, three or all four hydrogen atoms are substituted by identical or different radicals from the group consisting of (C₁-C₄)-alkyl, hydroxy-(C₁-C₄)-alkyl, (C₃-C₄)-cycloalkyl, (C₁-C₂)-alkoxy-(C₁-C₂)-alkyl, hydroxy-(C₁-C₂)-alkoxy-(C₁-C₂)-alkyl, (C₁-C₂)-mercaptoalkyl, phenyl and benzyl, where the radicals mentioned above are optionally substituted by one or more identical or different radicals from the group consisting of halogen, nitro, cyano, azido, (C₁-C₂)-alkyl, (C₁-C₂)-haloalkyl, (C₃-C₄)-cycloalkyl, (C₁-C₂)-alkoxy, (C₁-C₂)-haloalkoxy and phenyl, and where in each case two substituents at the nitrogen atom together optionally form an unsubstituted or substituted ring, or
(e) a quaternary phosphonium ion, where the (C₁-C₄)-alkyl radicals and the phenyl radicals are optionally mono- or polysubstituted by identical or different radicals from the group consisting of halogen, (C₁-C₂)-alkyl, (C₁-C₂)-haloalkyl, (C₃-C₄)-cycloalkyl, (C₁-C₂)-alkoxy and (C₁-C₂)-haloalkoxy, or
(f) a tertiary sulfonium ion, where the (C₁-C₄)-alkyl radicals and the phenyl radicals are optionally mono- or polysubstituted by identical or different radicals from the group consisting of halogen, (C₁-C₂)-alkyl, (C₁-C₂)-haloalkyl, (C₃-C₄)-cycloalkyl, (C₁-C₂)-alkoxy and (C₁-C₂)-haloalkoxy, or
(g) a tertiary oxonium ion, where the (C₁-C₄)-alkyl radicals are optionally mono- or polysubstituted by identical or different radicals from the group consisting of halogen, (C₁-C₂)-alkyl, (C₁-C₂)-haloalkyl, (C₃-C₄)-cycloalkyl, (C₁-C₂)-alkoxy and (C₁-C₂)-haloalkoxy, or
(h) a cation from the group of the following heterocyclic compounds comprising, pyridine, quinoline, 2-methylpyridine, 3-methylpyridine, 4-methylpyridine, 2,4-dimethylpyridine, 2,5-dimethylpyridine, 2,6-dimethylpyridine, 5-ethyl-2-methylpyridine, piperidine, pyrrolidine, morpholine, thiomorpholine, pyrrole, imidazole, 1,5-diazabicyclo[4.3.0]non-5-ene (DBN), and/or 1,8-diazabicyclo[5.4.0]undec-7-ene (DBU).

3. The herbicide combination as claimed in claim 1 which comprises, as component (A), 2-iodo-N-[(4-methoxy-6-methyl-1,3,5-triazin-2-yl)carbamoyl]benzenesulfonamide and/or a compound of formula (I) in which the cation (M⁺) is
a sodium ion, a potassium ion, a lithium ion, a magnesium ion, a calcium ion, an NH₄⁺ ion, a (2-hydroxyeth-1-yl)ammonium ion, a bis-N,N-(2-hydroxyeth-1-yl)ammonium ion, a tris-N,N,N-(2-hydroxyeth-1-yl)ammonium ion, a methylammonium ion, a dimethylammonium ion, a trimethylammonium ion, a tetramethylammonium ion, an ethylammonium ion, a diethylammonium ion, a triethylammonium ion, a tetraethylammonium ion, an isopropylammonium ion, a diisopropylammonium ion, a tetrapropylammonium ion, a tetrabutylammonium ion, a 2-(2-hydroxyeth-1-oxy)eth-1-ylammonium ion, a di(2-hydroxyeth-1-yl)ammonium ion, a trimethylbenzylammonium ion, a tri-((C₁-C₄)-alkyl)sulfonium ion, or a tri((C₁-C₄)-alkyl)oxonium ion, a benzylammonium ion, a 1-phenylethylammonium ion, a 2-phenylethylammonium ion, a diisopropylethylammonium ion, a pyridinium ion, a piperidinium ion, an imidazolium ion, a morpholinium ion, and/or a 1,8-diazabicyclo[5.4.0]undec-7-enium ion.

4. The herbicide combination as claimed in claim 1 which comprises, as component (B), at least one compound selected from the group consisting of:
dicamba; clopyralid; fluoroxypyr; picloram; triclopyr; quincloac, and aminocyclopyrachlor.

5. The herbicide combination as claimed in claim 1, comprising an effective amount of components (A) and (B) and/or at least one further component selected from the group consisting of agrochemically active compounds of a different type, formulation auxiliaries and additives customary in crop protection.

6. A method for the selective control of unwanted vegetation which comprises applying the herbicides (A) and (B) of the herbicide combination, as defined in claim 1, together or separately, optionally onto an area where plants grow.

7. The method as claimed in claim 6 for the selective control of unwanted vegetation by a pre-emergence method and/or a post-emergence method in wheat, corn, soybeans, sugarbeet, sugarcane, cotton, rice, beans, flax, barley, oats, rye, triticale, oilseed rape, potatoes, millet, pastureland and/or green/lawn areas.

8. An herbicide combination as defined in claim 1 for the selective control of unwanted vegetation.

9. An herbicide combination as defined in claim 2 for the selective control of unwanted vegetation.

10. An herbicide combination as defined in claim 3 for the selective control of unwanted vegetation.

11. An herbicide combination as defined in claim 4 for the selective control of unwanted vegetation.

12. An herbicide combination as defined in claim 5 for the selective control of unwanted vegetation.
